(19) United States
(12) Patent Application Publication
(10) Pub. No.: US 2024/0354502 A1
(43) Pub. Date: Oct. 24, 2024

(54) ARTICLE OF MANUFACTURE, SYSTEM, AND METHOD FOR TEACHING COMMONLY-USED PHONETIC VALUES AND VARIATIONS OF A WRITTEN AND SPOKEN LANGUAGE

(71) Applicant: ROD CABORN, SOQUEL, CA (US)

(72) Inventor: ROD CABORN, SOQUEL, CA (US)

(21) Appl. No.: 18/136,849

(22) Filed: Apr. 19, 2023

(51) Int. Cl. G06F 40/242; G09B 5/06; G09B 19/08

(52) U.S. Cl. CPC G06F 40/242

(57) ABSTRACT

A method for providing improved language instruction by limiting vocabulary within the scope of a given lesson or piece of media to regularly follow a certain schema of correlating grapheme (written character) to phoneme (spoken sound), such that consistent preliminary pronunciation rules can be established for the student and irregular or additional pronunciation rules can be introduced subsequently. A preferred medium of study material for instantiation of this approach may include quatrains containing only consistently pronounced words, which may also rhyme known words with words being taught newly.

### INCORPORATION BY REFERENCE

All publications, patents, and/or patent applications mentioned in this specification are herein incorporated by reference to the same extent as if each individual publication, patent, or patent application was specifically and individually indicated to be incorporated by reference.

All publications, patents, and patent applications mentioned in this specification are herein incorporated by reference to the same extent as if each individual publication, patent, or patent application was specifically and individually indicated to be incorporated by reference.

The present disclosure incorporates by reference the following publications, patents, and/or patent applications, in their entirety and for all purposes: U.S. Pat. Reg. No. 7,014,182, issued on Mar. 21, 2006, and titled “Apparatus and method of on demand printing, binding, and trimming a perfect bound book”; U.S. Pat. Reg. No. 6,142,721, issued on Nov. 7, 2000, and titled “Apparatus for and method of binding a book”; U.S. Pat. Reg. No. 3,957,287, issued on May 18, 1976, and titled “Book and cover therefor”; U.S. Pat. Reg. No. 3,973,787, issued on Aug. 10, 1976, and titled “Bookbinding system”; U.S. Pat. Reg. No. 5,868,539, issued on Feb. 9, 1999, and titled “Process and device for the manufacture of a book”; U.S. Pat. Reg. No. 4,420,282, issued on Dec. 13, 1983, and titled “Method for binding books”; U.S. Pat. Reg. No. 7,963,733, issued on Jun. 21, 2011, and titled “Apparatus for and a method of binding of a perfect bound book”; and U.S. Nonprovisional patent application Ser. No. 12/944,315, filed on May 12, 2011, and titled “Apparatus for and method of trimming of perfect bound books”.

The above-cited publications, patents, and/or patent applications are incorporated herein by reference in their entirety and for all purposes.

### Background of the Invention

### Field of the Invention

The present invention is related generally to language instruction, and more particularly to vocabulary curriculum structuring for language learning.

### Description of Related Art Including Information Disclosed Under 37 CFR 1.97 and 1.98

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Learning other languages besides one's own is not only a practically useful experience; it is also a personally rewarding and enriching experience that brings the world closer together. Fortunately for everyone, there are many ways to learn a new language, including but not limited to classes in school; college courses; clubs; online classes; and software like Rosetta Stone, Babel, and Duolingo.

Languages like English and French are notorious for minefields of spelling and pronunciation irregularities, which can make these languages more difficult to learn. As just a few frustrating examples from English: The words “cough,” “through,” and “sough,” do not rhyme with each other; “comb,” “tomb,” and “bomb” do not rhyme with each other; and “read” can be pronounced “red” or “reed,” depending on context. For more examples and illustrations of the many irregularities and pitfalls of English pronunciation that even fluent English speakers struggle with, the classic poem “The Chaos,” by Gerard Nolst Trenité, is recommended.

In view of the benefits of learning a second language, the high demand for aids in doing so accessibly, and the particular challenges offered by quirks of pronunciation and morphology, there is a long-felt need to provide improved solutions and approaches to language studies.

### BRIEF SUMMARY OF THE INVENTION

Towards these and other objects of the method of the present invention (hereinafter, “the invented method”) that are made obvious to one of ordinary skill in the art in light of the present disclosure, what is provided is a method for assembling educational materials for language learning that utilizes a subset of a lexicon wherein each written grapheme is consistently correlated to a single pronounced phoneme.

In language instruction, a distinction is often made between regular and irregular morphology. Most Romance languages include the morphological feature of verb conjugation that follows a predictable schema pattern for regular verbs. For instance, in Spanish: (hablar, to speak) yo hablo, tu hablas, el/ella/usted habla, nosotros hablamos, (vosotros habláis), ustedes hablan; (bailar, to dance) yo bailo, tu bailas, el/ella/usted baila, nosotros bailamos, (vosotros bailáis), ustedes bailan. The distinction is made between regular verbs, like hablar and bailar, which conjugate predictably, and irregular verbs, like ser (to be) and ir (to go), which have special conjugation patterns that don't follow the usual rules. The regular conjugation patterns can be taught as overall grammatical formulas (in the above example, that same conjugation schema applies to most verbs with infinitive forms ending in “—ar”), and the irregulars can be singled out as special cases. Language instruction benefits by drawing a distinction between regular and irregular morphology patterns (such as irregular verb conjugations or irregular noun declensions), but does not, generally, draw any such distinction between regular spelling/pronunciation correlation and irregular spelling/pronunciation correlation, except to remark on pitfalls specific to certain words or situations, i.e., “watch out for this often-mispronounced word.”

It is understood that [square brackets] are utilized herein as signifying usage of the International Phonetic Alphabet.

Spelling/pronunciation correlation, as used here, signifies correlation between a grapheme (such as a letter or syllable) and the phonetic sound that the letter should express. For instance, the letter A could be pronounced [α] as in “autumn” ([ [symbol] ] in British English), [æ] as in “apple,” [ [symbol] ] as in “about,” [i] as in “ear” (together with the letter E), [ [symbol] ] as in “may,” and so on. Correlation between the grapheme of the letter A and the corresponding phoneme (which might be [α], [ [symbol] ], [æ], [ [symbol] ], [i], [ [symbol] ], or something else depending on a speaker's accent) is not very strong in that set of examples, and it may be difficult for a language learner to formulate an understanding of how to know which pronunciation of A to use in a given situation, particularly if all of that pronunciation variety is thrown at the student all at once. A key concept of the invented method is that it may be preferable and beneficial to start with one correlation at a time. As an example, certain alternate preferred embodiments of the invented method introduce a set of vocabulary words that include only A's pronounced as [æ] first. It allows the student to get used to that rule before introducing “A” words that are associated with other pronunciations.

In one preferred application of aspects of the invented method, a list of grapheme (such as an alphabet) is mapped to a list of corresponding possible phonemes such that only one phoneme is assigned per grapheme. For graphemes having more than one possible pronunciation, such as the example above with the letter A, just one possible corresponding phoneme is selected to begin with. It is noted that the same phoneme may be mapped to multiple graphemes; for instance, inclusion of the letter K in the alphabet does not preclude the inclusion of a hard C, and inclusion of the letter S does not preclude inclusion of a soft C. With this mapped alphabet, a list of words is prepared which consists solely of words which comprise the mapped grapheme/phoneme correspondences; for instance, if the letter A is mapped to [æ], then the words “cat”, “hat”, “apple”, and “ant” may be allowed if the other letters correspond to their respective mappings; however, the word “all” would be excluded from this list.

It is noted that whether a grapheme as pronounced in a given word corresponds to a phonetic sound or not may depend on the ear and dialect of the speaker, and that two or more phoneme-to-grapheme instances need not be precisely identical to conform to the invented method; a reasonable margin of phonetic accuracy is acceptable here. As a practical example, most British dialects of English differentiate between the sounds [α] and [ [symbol] ], while most American English speakers' ears will tend to not distinguish between these, and those speakers will tend to pronounce all instances as [α] even when specifically attempting to say [ [symbol] ]. Further, which aspects of pronunciation can be inexact or vary by dialect but stay coherently the same language, may vary depending on the language. As an example, two completely different words in Mandarin Chinese may look or sound identical to an English speaker whose ear isn't trained to recognize tonal variation as a differentiating indicator of meaning. One skilled in the art, such as someone qualified to teach the language for which materials are being created, can exercise judgment as to how much of a variance for a given phoneme is allowable.

Instruction materials are prepared such that a language student starts out working with a lexicon consisting solely of words which follow the mapped alphabet formulated above. That way, the student can get trained in a certain set of consistent pronunciation rules before irregularity or variation is added in. Materials may be assembled, published, and provided in accordance with this curriculum approach. These may include curriculum guides, vocabulary lists, textbooks, picture books, workbooks, charts, poems, songs, short stories, videos, interactive software, and other types of media used in language education and study. The curriculum may start out with a certain set of “regular” pronunciation rules that don't change (e.g., the letter C is pronounced [k] as in “cat” and “clever”), then, once the student has practiced those, instruction may progress to words that break those rules or follow a subsequently introduced alternative set of rules (e.g., introducing the fact that sometimes the letter C can be pronounced [s] as in “cellophane” and “process” or that sometimes the letter C can combine into a [t∫] as in “cheddar cheese”). This might be done by composing new lessons utilizing a different set of rules, by introducing single words into the mix that break one or more rules and pointing these out as special, or some combination of these approaches. It is noted that, with some letters, irregularity is uncommon enough for there to be a “regular rule” and for any other usage to be rare, and, in other cases, there are simply multiple varieties to learn. (For instance, even experts often disagree over whether a short A or long A is relatively more “regular” or “irregular”, and in such cases, one might simply select which to teach first, not which to teach as regular as opposed to irregular.)

Usage of pronunciation-consistent vocabulary in language instruction as described above might be presented in several formats, but a preferred format is metered, rhyming poetic structures, such as quatrains. It is noted that many other verse, stanza, or poetic formats are also metered and/or rhyming, including but not limited to couplets, tercets, limericks, sonnets, pantoums, ballads, or indeed any structure a poet might invent, of which these are only a few of the most common. It is understood that practice of the invented method need not be restricted to any specific meter or verse format except as may be specifically limited by the claims. Further, lines might be of any meter, including but not limited to trochees, iambs, spondees, dactyls, and anapests; and may also be any number of feet per line, including but not limited to dimeter, trimeter, tetrameter, pentameter, or hexameter. Further also, even just within the category of quatrains, different rhyme patterns such as but not limited to ABAB, AABB, ABBA, ABCB, AAAA, or ABAC may be included as preferred, with same letters representing a rhyming pair of lines.

It is further noted that a structured piece of writing which is rhymed and/or metered has many unique benefits to recommend for educational content, particularly linguistic instruction. Books by Dr. Seuss, for instance, are widely acknowledged as staples for young English-speaking children, not only because these are fun books, but also because the language structures help kids learn about and play with language. Further, students who know the TV show School House Rock, for example, may already grasp the point that a catchy verse can aid a student in learning crucial pieces of information while also turning into an earworm. Songs overall are often easier to learn than dry facts, particularly when the listener enjoys the song, hears the song more than once, or learns to sing along. Well-written and engaging material which is also educational can be groundbreaking and beneficial to students at any age or level. As an example, Shakespeare's biographical plays were how many ordinary English people of that era first learned their country's history, long before it was common for the public to be educated or for books to be widely available. The Latin poet Lucretius famously wrote a treatise on Epicurean philosophy, “De Rerum Natura” (“On the Nature of Things”) entirely in flowery dactylic hexameter, holding that the entertaining poetic format was like a sweetener helping the audience swallow the bitter medicine of serious but important philosophy.

Further, and regarding linguistic understanding through poetic structure in particular, a regular metric structure or rhyme scheme provides cues as to vowel length, syllabification, accentuation, and which words are supposed to rhyme. In fact, classicists and other linguistic historians have been known to infer pronunciation aspects of dead languages such as vowel length and accentuation by studying metered works for patterns; the very structure of the text encourages the reader to pronounce words a certain way, and that fact has enabled scholars to at least partially reconstruct the sound of languages that are no longer spoken solely from available written sources.

Certain preferred embodiments of the invented method may comprise or include selecting a first plurality of words from a same spoken language, wherein each letter as present in all spellings of the first plurality of words shares a same common usage pronunciation in every instantiation of said letter within the first plurality of words; organizing the first plurality of words into a plurality of phrases; and visually presenting the plurality of phrases to a language learner. The method may further include at least four phrases being structured as a quatrain. The method may further include the quatrain instantiating a rhythmic pattern. The method may further include the quatrain instantiating a rhyming pattern. The method may further include a plurality of quatrains being formed that contains words selected from the first plurality of words. The method may further include a plurality of quatrains being formed that contain only words selected from the first plurality of words. The method may further include at least one word of the first plurality of words being selected from a second spoken language. The method may further include the first plurality of words being presented to a language learner in association with related imagery. The method may further include the first plurality of words being published in print media. The method may further include the first plurality of words being rendered on a video screen of a computational device. The method may further include at least one alternative word that instantiates an alternative phonetic value of a letter included in the first plurality of words being selected, and the at least one alternative word is presented to the language learner in a first combination containing words selected from the first plurality of words. The method may further include the at least one alternative word being presented visually distinctly from the words of the first plurality of words. The method may further include the at least one alternative word being presented in an alternative coloring that is visually distinct from a color by which the first plurality of words is presented. The method may further comprise a second alternative word, wherein the second alternative word instantiates an additional phonetic value of a letter included in the first plurality of words, and the second alternative word is presented in a second combination of words otherwise included in the first plurality of words. The method may further comprise a second combination of words that include words selected from the first plurality of words and a second alternative word, wherein the second alternative word includes the same letter of the first alternative word that instantiates the alternative phonetic value of said letter.

Certain preferred embodiments of the invented method may comprise or include storing a first plurality of words in a computer-readable medium, wherein each letter as present in all spellings of the first plurality of words shares a same common usage pronunciation in every instantiation of said letter within the first plurality of words; organizing the first plurality of words into a plurality of phrases; and visually rendering at least a selection of the plurality of phrases via a computational device to a language learner. The method may further comprise providing a digitized record of the plurality of phrases to the computational device via a network-enabled computer. The method may further comprise providing an accessible audio record of a pronunciation of at least a portion of the words included in the plurality of phrases to the computational device. The method may further associate an accessible audio record of a pronunciation of at least one the word included in the phrases with a digitized record of said at least one word. The method may further comprise selecting at least one alternative word instantiating an alternative phonetic value of a letter included in the plurality of phrases, and wherein the at least one alternative word is presented to the language learner within a phrase.

Certain still further alternative embodiments may further comprise including within the first plurality of words at least one instance of a selected grapheme that is associated with a second pronunciation that phonetically varies from an alternate pronunciation of another instance of the selected grapheme within a first plurality of graphemes presented within the first plurality of words. Certain additional alternative embodiments may further comprise including within the first plurality of words a plurality of β% instances of selected graphemes that are each associated with an alternate pronunciation that phonetically varies from a pronunciation of another instance of each selected grapheme within the first plurality of γ graphemes, wherein β% is less than or equal to ten of γ graphemes. Certain even still further alternative embodiments may further comprise including within the first plurality of words a plurality of β% instances of selected graphemes that are each associated with an alternate pronunciation that phonetically varies from a pronunciation of another instance of each selected grapheme within the first plurality of γ letters wherein β% is less than or equal to ten of γ letters. Certain other alternative embodiments may further comprise including within the first plurality of words a plurality of β% instances of selected graphemes that are each associated with an alternate pronunciation that phonetically varies from a pronunciation of another instance of each selected grapheme within the first plurality of γ words wherein β% is less than or equal to ten of γ words. Certain still further alternative embodiments may further comprise including within the first plurality of words a plurality of β% instances of selected graphemes that are each associated with an alternate pronunciation that phonetically varies from a pronunciation of another instance of each selected grapheme within the first plurality of γ quatrains wherein β% is less than or equal to ten of γ quatrains.

Certain yet further alternative embodiments may further comprise including within the first plurality of words at least one instance of a selected grapheme that is associated with a second pronunciation that phonetically varies from an alternate pronunciation of another instance of the selected grapheme within a first plurality of graphemes presented within the first plurality of words. Certain still further alternative embodiments may further comprise including within the first plurality of words a plurality of β% instances of selected graphemes that are each associated with an alternate pronunciation that phonetically varies from a pronunciation of another instance of each selected grapheme within the first plurality of γ graphemes, wherein β% is less than or equal to four of γ graphemes. Certain additional alternative embodiments may further comprise including within the first plurality of words a plurality of β% instances of selected graphemes that are each associated with an alternate pronunciation that phonetically varies from a pronunciation of another instance of each selected grapheme within the first plurality of γ letters, wherein β% is less than or equal to four of γ letters. Certain even further alternative embodiments may further comprise including within the first plurality of words a plurality of β% instances of selected graphemes that are each associated with an alternate pronunciation that phonetically varies from a pronunciation of another instance of each selected grapheme within the first plurality of γ words wherein β% is less than or equal to four of γ words. Certain further alternative embodiments may further comprise including within the first plurality of words a plurality of β% instances of selected graphemes that are each associated with an alternate pronunciation that phonetically varies from a pronunciation of another instance of each selected grapheme within the first plurality of γ quatrains wherein β% is less than or equal to four of γ quatrains.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWING(S)

The detailed description of some embodiments of the invention is made below with reference to the accompanying figures, wherein like numerals represent corresponding parts of the figures.

FIG. 1 is a diagram presenting key terminology and concepts in a visual format;

FIG. 2 is a first process chart presenting a first alternative embodiment of the invented method, applying the concepts of FIG. 1;

FIG. 3 is a second process chart presenting a second alternative embodiment of the invented method, applying the concepts of FIG. 1;

FIG. 4 is a third process chart presenting a third alternative embodiment of the invented method, applying the concepts of FIG. 1;

FIG. 5 is a fourth process chart presenting a fourth alternative embodiment of the invented method, applying the concepts of FIG. 1;

FIG. 6 is a fifth process chart presenting a fifth alternative embodiment of the invented method, applying the concepts of FIG. 1;

FIG. 7A is a first part of an example, presenting an example instance of the phoneme map of FIG. 1;

FIG. 7B presents an example poem composed in accordance with the phoneme map of FIG. 7A;

FIG. 8A is a charting of the grapheme to phoneme mapping of the first line of the example poem of FIG. 7B;

FIG. 8B is a charting of the grapheme to phoneme mapping of the second line of the example poem of FIG. 7B;

FIG. 8C is a charting of the grapheme to phoneme mapping of the third line of the example poem of FIG. 7B;

FIG. 8D is a charting of the grapheme to phoneme mapping of the fourth line of the example poem of FIG. 7B;

FIG. 9A is a second example poem which is modified from the example poem of FIG. 7B;

FIG. 9B is a second example phoneme map presenting the grapheme to phoneme correspondence in the modified poem of FIG. 9A;

FIG. 10 is a process chart presenting a sixth alternative embodiment of the invented method, applying the concepts of FIG. 1;

FIG. 11 is a diagram of an electronic communications network utilized to practice preferred embodiments of the invented method;

FIG. 12 is a block diagram of the student device of the electronic communications network of FIG. 11;

FIG. 13 is a block diagram of the instructor device of the electronic communications network of FIG. 11;

FIG. 14A is a first flow chart presenting accessing of downloadable software containing educational material as practiced from the perspective of the student device of FIG. 11;

FIG. 14B is a flow chart presenting the instructor device side of the download process presented in FIG. 14A;

FIG. 15 is a process chart presenting a process of the student device of FIG. 11 using a received software package to present an interface for a user to interact with, such as the example software interface of FIGS. 16A and 16B;

FIG. 16A is a first depiction of an example software interface presenting aspects of the example of FIGS. 7A through 9B in the context of an interactive software program;

FIG. 16B is a second depiction of the example software interface of FIG. 16A, presenting further aspects;

FIG. 17 is a depiction of an example presenting aspects of the example of FIGS. 7A through 9B in the context of a printed book such as a textbook or workbook written for a language learner;

FIG. 18 is a process chart presenting a possible process for assembling the phoneme map and phoneme map lexicon of FIG. 1;

FIG. 19 is a process chart presenting a further alternative embodiment of the invented method which includes permitting only a limited number of variants; and

FIG. 20 is an exemplary composition software interface adapted for facilitating practice of preferred aspects of the invented method including the variant budgeting of FIG. 19.

### DETAILED DESCRIPTION OF THE INVENTION

In the following detailed description of the invention, numerous details, examples, and embodiments of the invention are described. However, it will be clear and apparent to one skilled in the art that the invention is not limited to the embodiments set forth and that the invention can be adapted for any of several applications.

It is to be understood that this invention is not limited to particular aspects of the present invention described, as such may, of course, vary. It is also to be understood that the terminology used herein is for the purpose of describing particular aspects only and is not intended to be limiting, since the scope of the present invention will be limited only by the appended claims. Methods recited herein may be carried out in any logically possible order, as well as the recited order of events.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that, as used herein and in the appended claims, the singular forms “a,” “an,” and “the” include plural referents, unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example and not limitation, computer-readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to: RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

Additionally, it should be understood that any transaction or interaction described as occurring between multiple computers is not limited to multiple distinct hardware platforms, and could all be happening on the same computer. It is understood in the art that a single hardware platform may host multiple distinct and separate server functions.

Throughout this specification, like reference numbers signify the same elements throughout the description of the figures.

It is noted that the exemplary text and method steps presented herein and referencing of any of the Figures are offered to denote optional or preferred aspects of the invented method, and that none of the exemplary texts should be construed as to denote any limitation to the possible scope of embodiments of the invented method. This lack of indication of limitation applies to all specific exemplary text presented herein, the exemplary steps of generation of the exemplary text, including and not limited to alternate preferred quatrain embodiments, or other optional aspects and alternative literary patterns of poetry and prose that may be generated or authored in application of various preferred embodiments of the invented method. While selected embodiments have been chosen to illustrate the present invention, it will be apparent to those skilled in the art from this disclosure that various changes and modifications can be made herein without departing from the scope of the invention as defined in the appended claims.

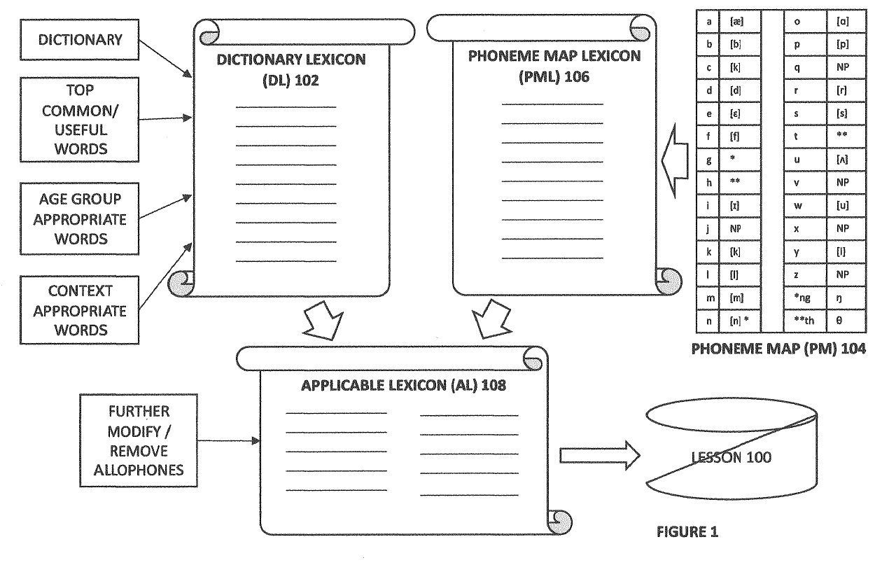

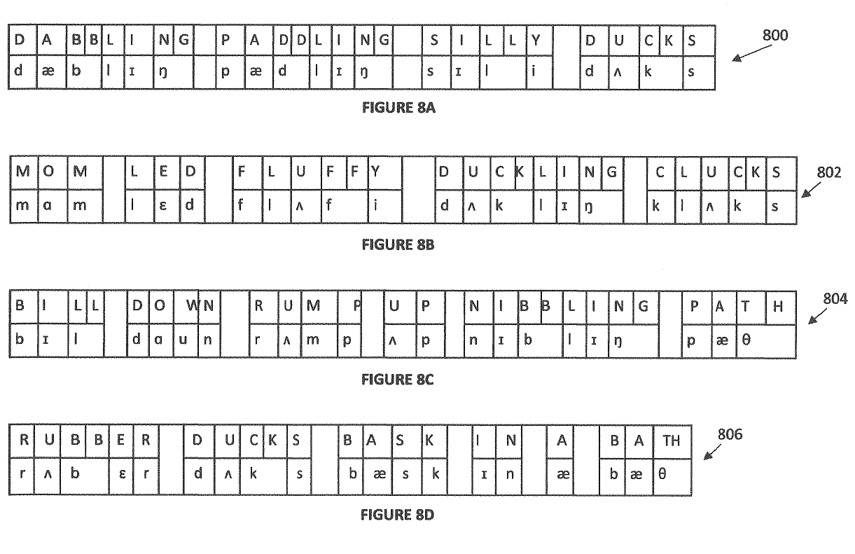

Referring now generally to the Figures and particularly to FIG. 1, FIG. 1 is a diagram presenting key terminology and concepts in a visual format. In preferred alternate application of the invented method, a lesson 100, such as a compilation of study materials, page/chapter of a textbook, or other unit of language education, is assembled utilizing a particular scope of vocabulary, as defined by (a.) what words are appropriate to the context, and (b.) what set of pronunciation rules the lesson 100 is following. Accordingly, in certain preferred embodiments of the invented method, a dictionary list 102 (DL) is assembled, which comprises only words considered appropriate to the context of the lesson 100. Assembly of the dictionary lexicon 102 is not concerned with phonetics, and indeed the same instance of the dictionary lexicon 102 might be reused in a plurality of instances of the lesson 100 which may all be directed to the same or similar audiences but utilizing different pronunciation rules. The dictionary lexicon 102 may be simply a dictionary, may be a “filtered” dictionary with non-age-appropriate words removed, or may focus or shape the lexicon of the lesson 100 in other ways, such as by limiting the scope of the lesson 100 to the ‘Top 1000 Most Used Words’ of the studied language, or adding terms that may be germane or of interest to a certain audience of student, such as including or emphasizing medical terms for an audience of language students who are doctors or nurses learning the language for use in their profession. It is further noted that certain embodiments of the invented method may omit the dictionary lexicon 102, and the dictionary lexicon 102 may only be necessary where words otherwise phonetically allowable should be systematically omitted from use for a non-phonetic reason, such as but not limited to complexity, obscurity, or obscenity. Further, a phoneme map 104 is assembled, which is an alphabet matrix wherein a plurality of graphemes is associated with a plurality of phonemes. A “grapheme” is defined as a unit of written language (such as a letter or combination of letters) which represents a given phoneme; and a “phoneme” is defined as a perceptually distinct unit of spoken sound which distinguishes one word from another in a specified language. It is emphasized that a range of actual spoken sounds may all be considered to be the same phoneme according to this definition, and the key criterion is perceptual distinctiveness—someone who understands the language can discern with reasonable certainty that one word, and not another, is being spoken, even if dialects vary among individual speakers—not exact conformity to a single “pure vowel” or “pure consonant” sound. Particularly in this context, one is encouraged to think of phonemes as ranges of sound variation “within the reasonably intelligible vicinity” of whatever sound is notated, and also to understand that what is considered the “reasonably intelligible vicinity” is decided as a judgment call by the practitioner of the method. It is noted that each of the letters and letter combinations in the first and fourth columns of the five-column phoneme map 104 presented here (A-Z and also —ng— and —th—) are all examples of graphemes; the second and fifth columns list phonemes associated with each grapheme, notated in [brackets] using the International Phonetic Alphabet. (It is further noted that this small depiction of the phoneme map 104 is present in FIG. 1 to provide a graphical representation of the phoneme map 104 in this context, and the same phoneme map 104 presented in FIG. 1 is presented in FIG. 7A in a larger size and less condensed format.) In preferred implementation of the invented method, the phoneme map 104 for a beginner-level instance of the lesson 100 may associate each grapheme with exactly one phonetic pronunciation, which may comprise a single phoneme or reasonable variance of phonemes, such that for any given grapheme in the context of the lesson 100, there is one consistent pronunciation for that grapheme to be learned at once. It is noted that formulation of a more advanced instance of the lesson 100 might be oriented around a more “lenient” phoneme map 104 wherein a grapheme might be used in a plurality of ways, such as to represent more than one pronunciation of a same grapheme within a same context. (For instance; the phrase “amazing apple” combines more than one different pronunciation of “A”.) Based on the phoneme map 104, a phoneme map lexicon 106 (PML) is assembled, such that the phoneme map lexicon 106 is a list of words whose correlation of spelling to pronunciation is consistent with the phoneme map 104 as already established. It is noted that, if the phoneme map 104 changes, the phoneme map lexicon 106 may change also.

It is further noted that language speakers generally approximate and vary pronunciation in their speech, even within a same dialect, that a certain range of variance off of a “pure vowel” or “pure consonant” sound may still be considered to correspond to a given phoneme by a typical native language speaker. Phonemes as discussed herein may be understood to incorporate a reasonable range of variance, at a degree of precision suited more to the endeavor of learning to functionally speak a language than to that of high-level linguistic analysis. It is noted that many dialects of the same language may pronounce a same element of a same word differently, and yet remain close enough to be mutually intelligible; the “right way to pronounce” a given word can depend on who is asked. Decisions of how much variance is reasonable, how specific words are considered to be pronounced, and which pronunciations of which graphemes within which words constitute instances of a certain pronunciation of a certain phoneme being taught (i.e. considered within an acceptable range of approximation), are all subjective decisions to be made by a language instructor composing materials, recognizing that that instructor's decisions will also be biased by that instructor's own ear and dialect. Language students learning this way will therefore still be prone to picking up their instructor's accent, which is already a known quirk of language instruction for this same reason.

An applicable lexicon 108 (AL) is then assembled, beginning with the intersection set of words which are included both in the dictionary lexicon 102 and also in the phoneme map lexicon 106: that is, the set of words which are both contextually appropriate and also consistent with the phoneme map 104. It is noted that the applicable lexicon may be further edited, and some further edits may include deleting of allophones (words spelled differently but pronounced the same; a.k.a. homonyms or homophones) to alleviate potential confusion for a beginner. It is understood that the applicable lexicon 108 is a lexicon of all words considered “within bounds” for formulating the lesson 100, and this is also ultimately a matter of subjective decisions made by the language instructor composing the lesson. It is noted that the dictionary lexicon 102, the phoneme map lexicon 106, and the applicable lexicon 108 are all listings of words; no example words are presented as list items in this graphic, and lines are drawn on these graphically represented “lists” as an abstract representation of list text.

It is understood that a word of an alternate human language (“second language word”) may be included in the applicable lexicon 108 if said second language word is commonly written with only graphemes indexed by the phoneme map 104, and may be pronounced by the associated phoneme values as found in the phoneme map 104, then said second language word may be included in the phoneme map lexicon 106 in the composing process of FIG. 1 in generating the lesson 100, and/or other alternate preferred embodiments of text in accordance with various alternate preferred embodiments of the invented method.

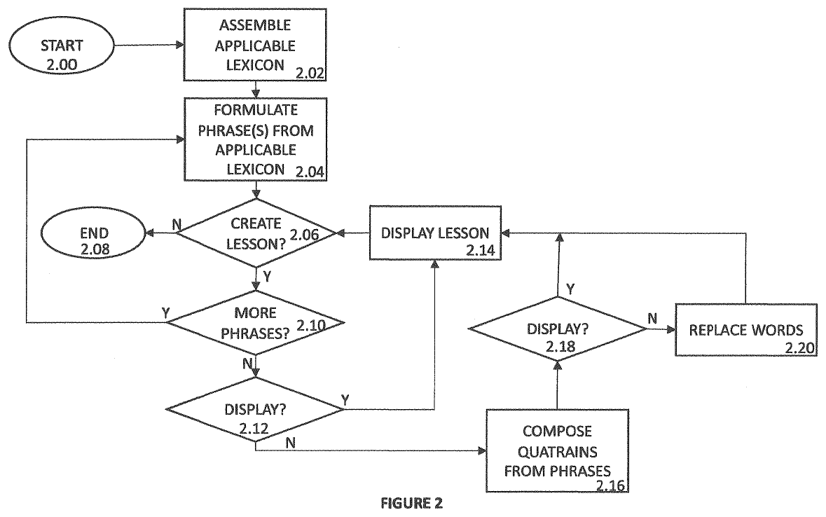

Referring now generally to the Figures and particularly to FIG. 2, FIG. 2 is a first process chart presenting a first alternative embodiment of the invented method. At step 2.00, the process starts. At step 2.02, the applicable lexicon 108 is assembled. Subsequent process charts present this step of the process in more specific detail; it is understood that this step results in a listing of words from which the phrases of step 2.04 can be formulated. In step 2.04, words are selected from the applicable lexicon 108 of step 2.02 and arranged into one or more phrases. It is noted that not all words from the applicable lexicon 108 have to be utilized, but that no words are utilized which are not in the applicable lexicon 108 listing; the applicable lexicon 108 defines what words are “in-bounds” for this purpose. At step 2.06, it is determined whether a lesson should be formulated utilizing the phrases of step 2.04. It is noted that a decision was also made to initiate the process in the first place, but placing a decision step of whether to stop at this point in the process provides for preliminary assembly of an applicable lexicon 108 and some phrases before deciding whether what has been assembled is worth using or applicable to a lesson plan, and further, that this decision step acts as a conditional node for controlling a loop wherein multiple lessons might be formulated and presented based on a same applicable lexicon 108 (as derived from a same phoneme map 104 and dictionary lexicon 102). If not, then the process ends at step 2.08. Otherwise, the process continues with step 2.10, at which it is determined whether more phrases should be formulated. A lesson might be presented which contains only one phrase, a series of individual phrases, a grouping of related phrases such as a poem, or something else; this step determines whether the correct pieces are already present, or whether more phrases are needed. If no more phrases are needed, and only a single phrase or series of phrases is being presented, the lesson may be ready to present; this is determined at step 2.12. If so, then the lesson is presented at step 2.14, such as by display on a screen, printing in a worksheet or book for a student to use, or inclusion in a curriculum for a language teacher to use. It is noted that the lesson content as assembled may be further supplemented with additional presentation elements such as images, explanatory text, audio, or video, depending on the presentation medium being utilized. Otherwise, at step 2.16, at least four of the phrases are assembled together into one or more quatrains, which are rhyming verses with four lines. Once the one or more quatrains is composed, the lesson may be ready; this is determined at step 2.18. If not, then the quatrain(s) may be further modified by replacement of one or more words, such as to specifically illustrate a linguistic concept, before proceeding to step 2.14 and delivering the completed lesson material.

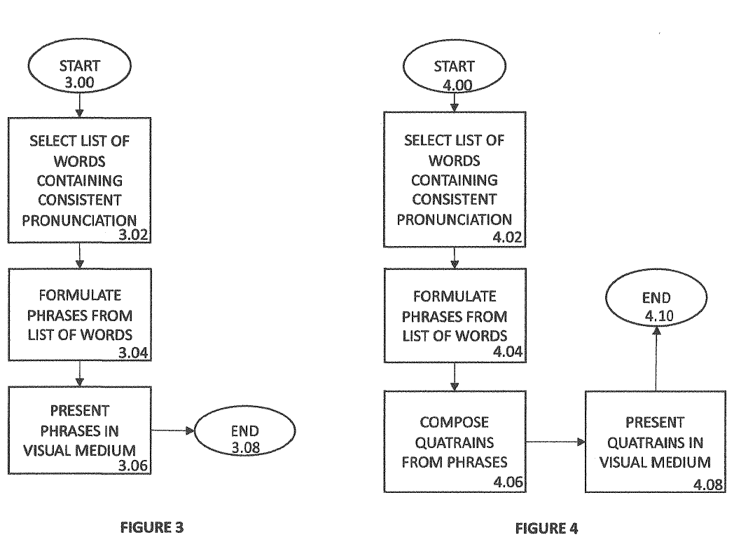

Referring now generally to the Figures and particularly to FIG. 3, FIG. 3 is a second process chart presenting a second alternative embodiment of the invented method. At step 3.00, the process starts. At step 3.02, the phoneme map lexicon 106 is assembled. At step 3.04, one or more phrases is formulated from the assembled list of words. At step 3.06, the one or more phrases is presented in a visual medium. At step 3.08, the process ends.

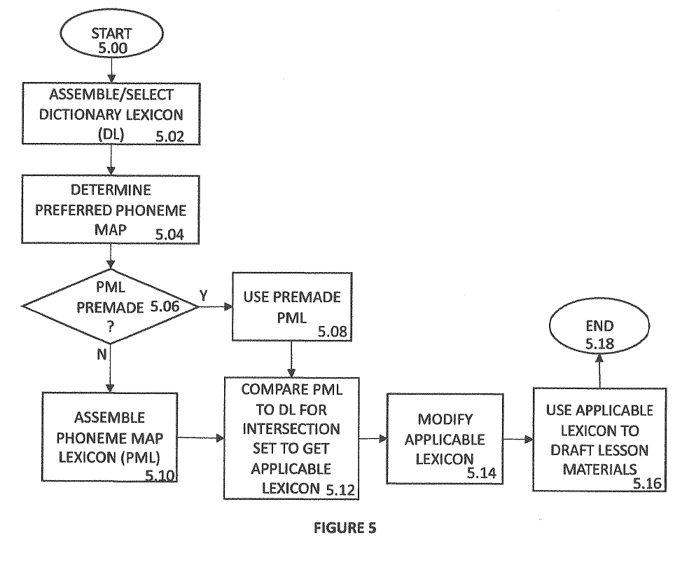

Referring now generally to the Figures and particularly to FIG. 4, FIG. 4 is a third process chart presenting a third alternative embodiment of the invented method. At step 4.00, the process starts. At step 4.02, the phoneme map lexicon 106 is assembled. At step 4.04, a plurality of phrases is formulated based on the phoneme map lexicon 106. At step 4.06, one or more quatrains is assembled from the plurality of phrases. At step 4.08, the one or more quatrains is presented in a visual medium. At step 4.10, the process ends.

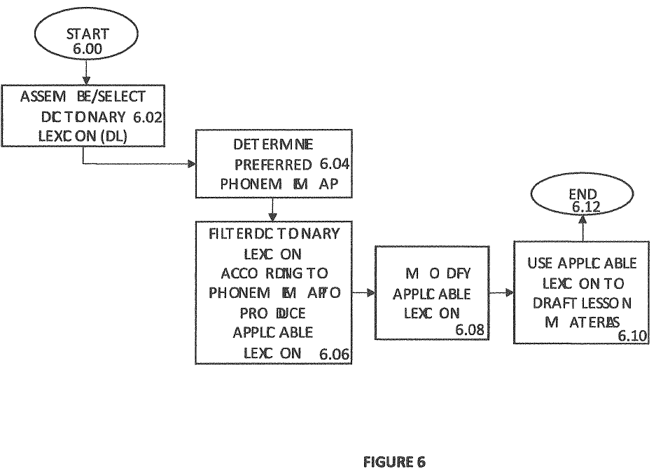

Referring now generally to the Figures and particularly to FIG. 5, FIG. 5 is a fourth process chart presenting a fourth alternative embodiment of the invented method. At step 5.00, the process starts. At step 5.02, the dictionary lexicon 102 is assembled or selected. At step 5.04, the phoneme map 104 is assembled or selected; it is decided which phonemes are mapped to which graphemes within the scope of the current process (i.e. which pronunciation of each letter is being used). In step 5.06, there may already be a phoneme map lexicon 106 formulated for the phoneme map 104 of step 5.04, or a list of words consistent with that phoneme map 104 may need to be generated. If a premade phoneme map lexicon 106 is available, at step 5.08 that phoneme map lexicon 106 is used. Otherwise, at step 5.10, the phoneme map lexicon 106 is assembled. It is noted that even if the phoneme map lexicon 106 is available premade, the option remains to make a new one if the phoneme map lexicon 106 as premade is found unsuitable or a refresh is otherwise indicated. At step 5.12, the applicable lexicon 108 is assembled by finding the set intersection of the dictionary lexicon 102 of step 5.02 and the phoneme map lexicon 106 of step 5.08 or 5.10: that is, all words that appear on both (a.) the list of words relevant to the context and (b.) the list of words consistent with the pronunciation codified in the phoneme map 104 in use. At step 5.14, the applicable lexicon 108 may be further modified prior to use, such as by removing allophones (words that sound the same but are spelled differently, such as “there” and “they're”), as these are likely to confuse a new language learner. Other modifications might include removing other words or categories of words deemed to be confusing, or adding to the applicable lexicon 108 any word or words the instructor may consider suitable to include. At step 5.16, the applicable lexicon 108 is utilized to draft one or more instances of the lesson 100, such as but not limited to phrases, quatrains, textbook text/images, workbook text/images, computer game screen displays, lesson plans for a teacher, and so on. At step 5.18, the process ends.

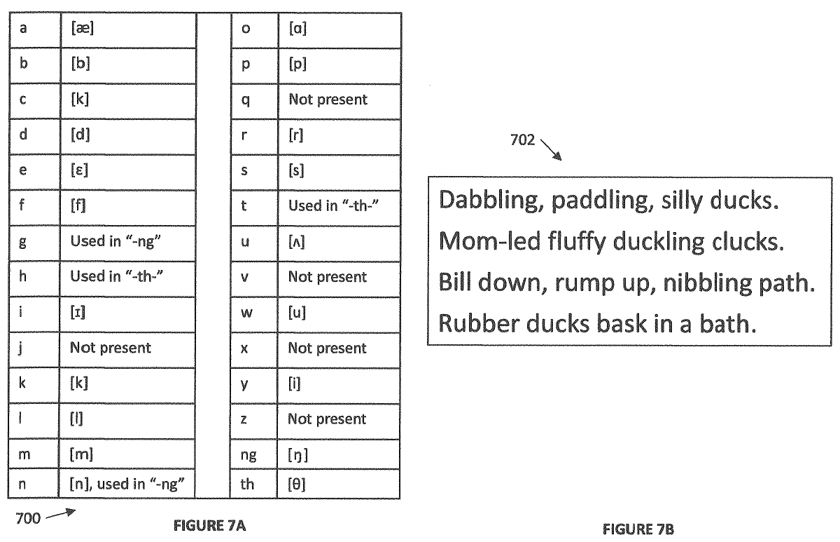

Referring now generally to the Figures and particularly to FIG. 6, FIG. 6 is a fifth process chart presenting a fifth alternative embodiment of the invented method. At step 6.00, the process starts. At step 6.02, the dictionary lexicon 102 is assembled or selected. At step 6.04, the phoneme map 104 is determined. At step 6.06, the dictionary lexicon 102 is filtered according to the phoneme map 104. It is noted that this might be considered an alternative or condensed process as contrasted to generating the phoneme map lexicon 106 from the phoneme map 104 and then selecting all words which are present both in the dictionary lexicon 102 and the phoneme map lexicon 106 to produce an intersection listing to at least provide most of the applicable lexicon 108. At step 6.08, the applicable lexicon 108 may be modified, as discussed at least with regard to FIG. 5. At step 6.10, the applicable lexicon 108, now complete, is utilized to draft the lesson 100. At step 6.12, the process ends.

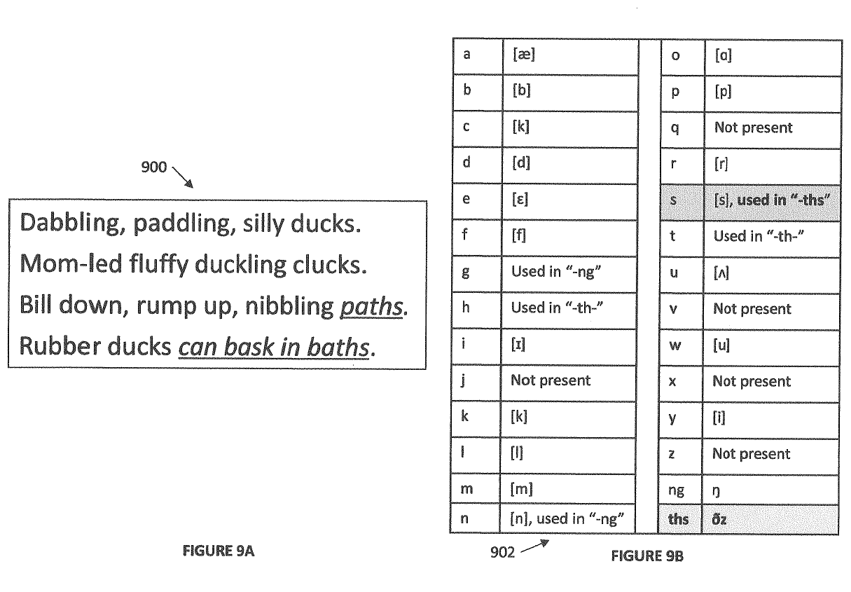

Referring now generally to the Figures and particularly to FIG. 7A, FIG. 7A is a first part of an example, presenting an example phoneme map 700, which is an instance of the phoneme map 104 which is associated with an example of FIGS. 7A through 8D. The example phoneme map 700 charts grapheme to phoneme correspondence as applied in an example poem 702 of FIG. 7B. In the leftmost and fourth from left columns, the example phoneme map 700 lists alphabetical letters A through Z, and also the graphemes “—ng—” and “—th—”, as these happen to be included in the example poem 702 of FIG. 7B and signify sounds that the singular letters do not. In the second from left and rightmost columns, the example phoneme map 700 indicates usage of the adjacent grapheme, either as a phoneme consisting of an International Phonetic Alphabet notation in brackets, or a different notation such as “Not present” for graphemes which do not appear in the example poem 702 but are listed to maintain a reader-friendly A-Z alphabet order, or “used in —ng—” or “used in —th—”, indicating that, while this letter is present in the example poem 702, the letter is only present as part of the indicated combination. It is noted that, while the example poem 702 contains no instances of the letters “T”, “H”, and “G” in single isolation, these letters appear in the combinations “—th—” and “—ng—”; the example phoneme map 700 denotes this. By contrast, the example poem 702 does contain instances of both singular letter “N” (at least as in “down”, “nibbling”, and “in”) and the letter “N” as part of the combination “—ng—” (at least as in “dabbling”, “paddling”, “duckling”, and “nibbling”). It is noted that a practitioner of the invented method might use discretion as to what extent the student is expected to distinguish “—th—” as a grapheme distinct from the letters “T” and “H” in isolation, or how to introduce this concept. It is noted that, as the example phoneme map 700 recites, within the scope of the example of FIGS. 7A, 7B, 8A, 8B, 8C, and 8D: the grapheme “a” is pronounced [æ] as in “apple”; the grapheme “b” is pronounced [b] as in “baker”; the grapheme “c” is pronounced [k] as in “cat”; the grapheme “d” is pronounced [d] as in “dog”; the grapheme “e” is pronounced [ε] as in “bed”; the grapheme “f” is pronounced [f] as in “fish”; the grapheme “g” is only used in the context of “—ng—”; the grapheme “h” is only used in the context of “—th—”; the grapheme “i” is pronounced [ι] as in “fish”; the grapheme “j” is not present; the grapheme “k” is pronounced [k] as in “koala”; the grapheme “l” is pronounced [l] as in “koala”; the grapheme “m” is pronounced [m] as in “mouse”; the grapheme “n” is pronounced [n] as in “noodle”, and also used in the context of “—ng—”; the grapheme “o” is pronounced [α] as in “octopus”; the grapheme “p” is pronounced [p] as in “paddle”; the grapheme “q” is not present; the grapheme “r” is pronounced [r] as in “rule”; the grapheme “s” is pronounced [s] as in “sit”; the grapheme “t” is only used in the context of “—th—”; the grapheme “u” is pronounced [Λ] as in “up”; the grapheme “v” is not present; the grapheme “w” is pronounced [u], specifically within the context of the diphthong [αu] in the word “down”; the grapheme “x” is not present; the grapheme “y” is pronounced [i] as in “silly”; the grapheme “z” is not present; the grapheme “ng” is pronounced [η] as in “duckling”; and the grapheme “th” is pronounced [θ] as in “bath”.

It is noted that mapping of phoneme to grapheme is also influenced by the dialect of the speaker of a language, and speakers of the same language having different dialects might pronounce the same word differently. How words are considered to be pronounced for the purposes of practicing the invented method is a subjective judgment call to be made by the one of ordinary skill in the art in composing the materials. Further, it is emphasized that “wiggle room” for reasonable variance in pronunciation to still be considered a close enough correspondence to the same phoneme to be used, is preferred over exact, strict linguistic precision, and how much variation is reasonable and which particular words or pronunciations are “within bounds” or not is a subjective decision to be made by the one of ordinary skill in the art, as a competent speaker of the language being taught and an expert in the field of the instruction of that language.

Referring now generally to the Figures and particularly to FIG. 7B, FIG. 7B presents an example poem 702 in accordance with a preferred embodiment of the invented method, which recites as follows:
Dabbling, paddling, silly ducks.
Mom-led fluffy duckling clucks.
Bill down, rump up, nibbling path.
Rubber ducks bask in a bath.

It is emphasized that the example poem 702 conforms to the schema of pronunciation mapped out in the example phoneme map 700 of FIG. 7A, within a reasonable range of variance in pronunciation as judged by the composer, defined herein as one of ordinary skill in the art practicing the invented method, of the example. For further indication as to which judgments the composer of this example has made, please note FIGS. 8A through 8D. It is further emphasized that the example poem 702 is an example of a quatrain comprised of four phrases, in accordance with certain embodiments of the invented method, and that the example poem has an AABB rhyme pattern and is metered in iambic tetrameter. It is further noted that the example poem 702 is about the subject matter of ducks, and that this may, depending on the age of the student, be an example either of age-appropriate material for a young child, or an accessible, easily-understood, and hopefully catchy starting point for an older student learning the basics. It is additionally noted that multiple other phrases, poems, or other materials suitable for inclusion in a language study curriculum might be generated based on the example phoneme map 700, of which the example poem 702 is only one representative example for the purposes of illustration. It is noted that the example poem 702 was selected as an example element to visually demonstrate the concept, and that no limitations should be construed as to the invented method including this specific text, the subject matter of ducks, or other aspects specific to this particular example poem.

Referring now generally to the Figures and particularly to FIG. 8A, FIG. 8A is a table containing the first line of the example poem 702, wherein the consistent correspondence of one phoneme per grapheme as listed in the example phoneme map 700 is further illustrated by linking of individual graphemes of words of the example poem 702 to corresponding International Phonetic Alphabet phonemes, according to the discretion of the composer of the example poem 702. FIGS. 8A through 8D might be considered a grapheme-by-grapheme accounting of the phonemes present in the example poem 702, illustrating that the correspondence of grapheme to phoneme is consistent throughout within a range of variance judged reasonable by the composer. It is noted that the several pairs of same phoneme consonants in the example poem 702 (e.g. “bb”, “dd”, “ll”, “ck”) may prompt or facilitate a discussion or language lesson regarding the pattern of pronouncing consecutive same consonants associated with a same phoneme as a single instance of that phoneme, rather than as two distinct sounds, and further that this can be easy to recognize with a pair of the same letter but may also occur as two different consonants having a same sound, such as “ck”, which is spotlighted in a poem about ducks.

Referring now generally to the Figures and particularly to FIG. 8B, FIG. 8B is a table containing the second line of the example poem 702, wherein the consistent correspondence of one phoneme per grapheme as listed in the example phoneme map 700 is further illustrated by linking of individual graphemes of words of the example poem 702 to corresponding International Phonetic Alphabet phonemes.

Referring now generally to the Figures and particularly to FIG. 8C, FIG. 8C is a table containing the third line of the example poem 702, wherein the consistent correspondence of one phoneme per grapheme as listed in the example phoneme map 700 is further illustrated by linking of individual graphemes of words of the example poem 702 to corresponding International Phonetic Alphabet phonemes.

Referring now generally to the Figures and particularly to FIG. 8D, FIG. 8D is a table containing the fourth line of the example poem 702, wherein the consistent correspondence of one phoneme per grapheme as listed in the example phoneme map 700 is further illustrated by linking of individual graphemes of words of the example poem 702 to corresponding International Phonetic Alphabet phonemes.

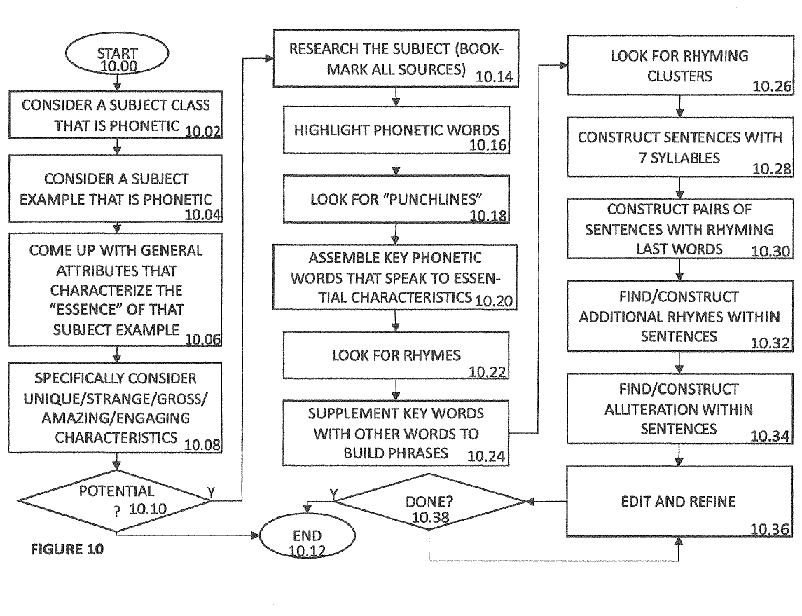

Referring now generally to the Figures and particularly to FIG. 9A, FIG. 9A is a second example poem 900, wherein a few words have been strategically switched out of the example poem 702 as underlined, in accordance with certain additional aspects of preferred embodiments of the invented method. The second example poem 900 recites as follows:
Dabbling, paddling, silly ducks.
Mom-led fluffy duckling clucks.
Bill down, rump up, nibbling paths.
Rubber ducks can bask in baths.

Underlining is utilized to indicate where words have been substituted. Specifically, “path” of the example poem 702 has been pluralized to “paths”; and “bask in a bath” has been pluralized and rephrased to “can bask in baths”. Particularly in combination and contrast with the example poem 702, the second example poem 900 might be illustrative of concepts such as the grapheme “—th—” becoming voiced when pluralized (compare “path” [p æ θ] to “paths” [p æ ð z]), and further additionally contrasted with the more regular unvoiced pluralization of “ducks” and “clucks” directly above. It is further noted that the substituted words are visually distinguished from the remaining unmodified context of the example poem 702, and that while the visual distinction presented here is composed for inclusion in a black-and-white image, similar such emphasized words might be emphasized in a variety of ways such as but not limited to color coding or font color, bold, italic, underline, highlighting, font size, font type, illustrations or animations around the emphasized text, or something else that is suitably visually distinctive for this purpose. It is noted that the second example poem 900 was selected as an example element to visually demonstrate the concept, and that no limitations should be construed as to the invented method including this specific text, the subject matter of ducks, or other aspects specific to this particular example poem.

Referring now generally to the Figures and particularly to FIG. 9B, FIG. 9B is a second example phoneme map 902, which is an instance of the phoneme map 104 associated with the second example poem 900. Modifications to the phoneme map 702 of FIG. 7B, in view of the word replacements, are highlighted in the table, specifically the new usage of “—ths—” as pronounced [ðz], and the usage of the letter “S” in this additional capacity.

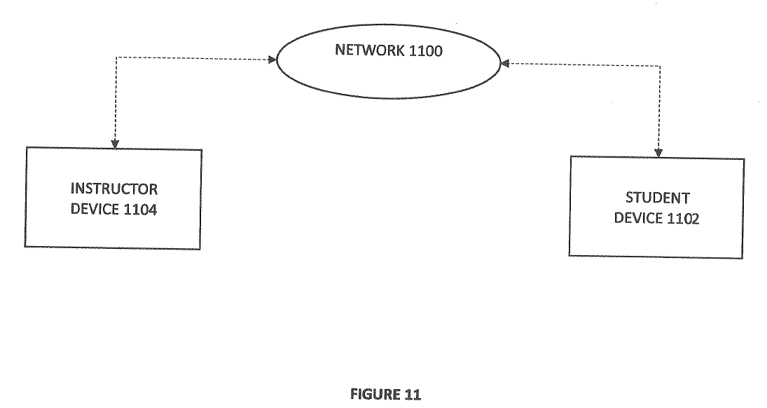

Referring now generally to the Figures and particularly to FIG. 10, FIG. 10 is a process chart presenting a sixth alternative embodiment of the invented method, specifically a more “organic” process for selecting subject matter, defining the applicable lexicon 108, and drafting a composition such as a poem. At step 10.00, the process begins. At step 10.02, a subject class that is phonetic is considered. At step 10.04, a subject example that is phonetic is considered. At step 10.06, a listing of general attributes that characterize the “essence” of the subject example of step 10.04 is generated. At step 10.08, distinctive or interesting characteristics of the subject example of step 10.04 are specifically emphasized for consideration, such as characteristics which are unique, strange, gross, amazing, or engaging. At step 10.10, it is determined whether the subject example of step 10.04 has potential as material for formulating an instance of the lesson 100. If not, then the process may end at step 10.12. Otherwise, the process continues with step 10.14, and the subject matter is researched; keeping a record of one's sources of information is recommended. At step 10.16, phonetic words are highlighted. At step 10.18, it is emphasized to look for “punchlines”. At step 10.20, a listing of key phonetic words that speak to essential characteristics is assembled. At step 10.22, the listing of step 10.20 is searched for rhymes. At step 10.24, selected key words are supplemented with other words to build phrases around these key words. At step 10.26, the assembled phrases are searched for rhyming clusters. At step 10.28, sentences with seven syllables are constructed. At step 10.30, pairs of sentences with rhyming last words are constructed. At step 10.32, additional rhymes within sentences are constructed. At step 10.34, alliteration within sentences is found and/or constructed. At step 10.36, the composition is edited and refined. At step 10.38, it is determined whether the composition is done or further edits or revisions are indicated. Once the composition is done, the process ends at step 10.12.

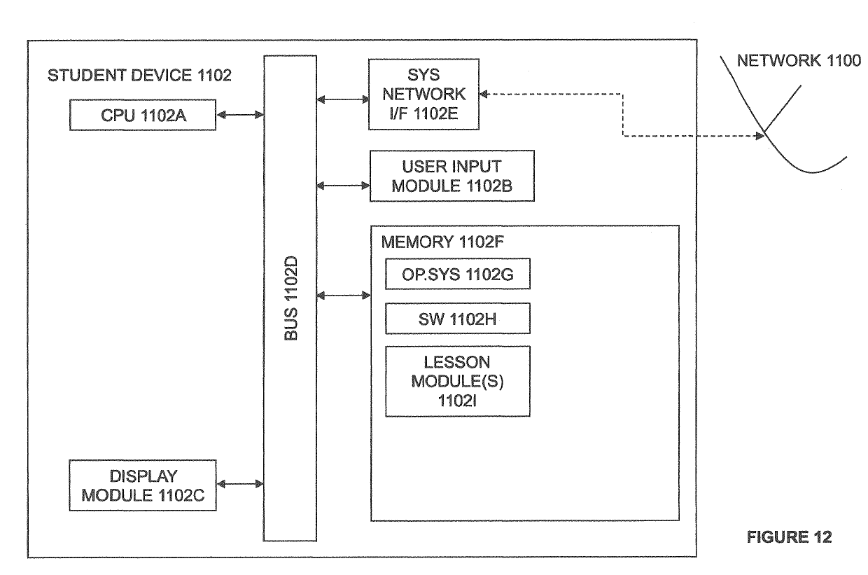

Referring now generally to the Figures, and particularly to FIG. 11, FIG. 11 is a diagram of an electronic communications network 1100 which bi-directionally communicatively couples at least two computers or devices, represented here as a student device 1102 which receives and presents digital material pertaining to the lesson 100 as distributed utilizing an instructor device 1104. The instructor device 1104 may be or represent a computing device used to assemble, store, and distribute instances of the lesson 100, such as a personal or work computer used by a teacher or an author of educational material. It is noted that, particularly depending upon the size of the educational material production enterprise, these functions may be distributed to multiple computers on the same network, such as by setting up a dedicated server to receive and archive new material from one or more authors' individual workstations and make the contents of that repository available for authorized access and download such as through an online store. The single instructor device 1104 presented here may be viewed as either an assumption for the sake of simplicity in explanation that a single teacher is composing lessons and distributing the lessons all on a single computer as a very small business, or as collectively representing the “party” accessible on the network 1100 (which could actually be a whole office of computers) as the source of educational materials authored and distributed according to the invented method.

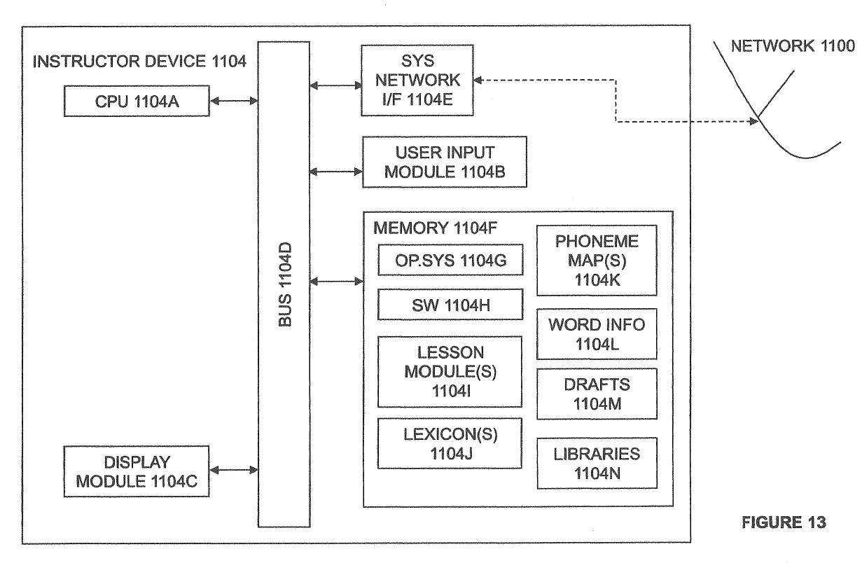

Referring now generally to the Figures, and particularly to FIG. 12, FIG. 12 is a block diagram of the student device 1102 of the electronic communications network 1100 of FIG. 11 and displaying together both hardware and software aspects thereof, wherein the student device 1102 comprises: a central processing unit or “CPU” 1102A; a user input module 1102B; a display module 1102C; a software bus 1102D bi-directionally communicatively coupled with the CPU 1102A, the user input module 1102B, the display module 1102C; the software bus 1102D is further bi-directionally coupled with a network interface 1102E, enabling communication with alternate computing devices by means of the network 100; and a memory 1102F. The software bus 1102D facilitates communications between the above-mentioned components of the student device 1102. The memory 1102F of the student device 1102 includes a software operating system OP.SYS 1102G. The software operating system OP.SYS 1102G of the student device 1102 may be selected from freely available, open source and/or commercially available operating system software, to include but not limited to a.) a Z8 G4 computer workstation marketed by Hewlett Packard Enterprise of San Jose, California and running a Red Hat Linux™ operating system marketed by Red Hat, Inc. of Raleigh, North Carolina; (b.) a Dell Precision™ computer workstation marketed by Dell Corporation of Round Rock, Texas, and running a Windows™ 10 operating system marketed by Microsoft Corporation of Redmond, Wash.; (d.) a Mac Pro workstation running MacOS X™ as marketed by Apple, Inc. of Cupertino, Calif.; (e.) a tablet such as an iPad Pro running iPadOS 16 as marketed by Apple, Inc. of Cupertino, Calif.; (f.) a smart phone such as an iPhone 14 Pro running iOS 16 as marketed by Apple, Inc. of Cupertino, Calif.; or (g.) other suitable computational system or electronic communications device known in the art capable of providing networking and operating system services as known in the art. The exemplary software program SW.SRC 1102H consisting of executable instructions and associated data structures is optionally adapted to enable the student device 1102 to perform, execute and instantiate all elements, aspects and steps as required of the student device 1102 to practice the invented method in its various preferred embodiments in interaction with other devices of the network 100. The memory 1102F may further include one or more lesson modules 1102I, as downloaded over the network 1100 or otherwise obtained and installed for interactive presentation to a student utilizing the user interface elements of the student device 1102.

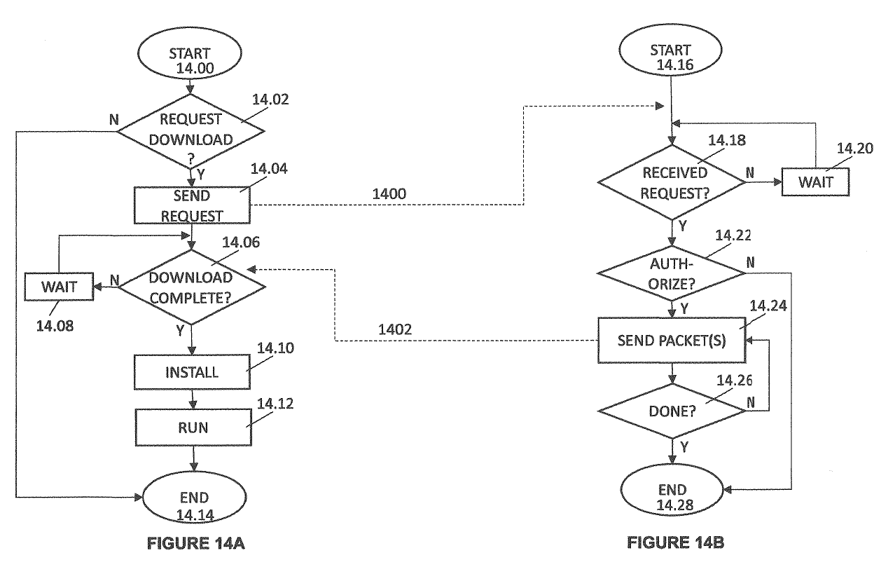

Referring now generally to the Figures, and particularly to FIG. 13, FIG. 13 is a block diagram of the instructor device 1104 of the electronic communications network 1100 of FIG. 11 and displaying together both hardware and software aspects thereof, wherein the instructor device 1104 comprises: a central processing unit or “CPU” 1104A; a user input module 1104B; a display module 1104C; a software bus 1104D bi-directionally communicatively coupled with the CPU 1104A, the user input module 1104B, the display module 1104C; the software bus 1104D is further bi-directionally coupled with a network interface 1104E, enabling communication with alternate computing devices by means of the network 100; and a memory 1104F. The software bus 1104D facilitates communications between the above-mentioned components of the instructor device 1104. The memory 1104F of the instructor device 1104 includes a software operating system OP.SYS 1104G. The software operating system OP.SYS 1104G of the instructor device 1104 may be selected from freely available, open source and/or commercially available operating system software, to include but not limited to a.) a Z8 G4 computer workstation marketed by Hewlett Packard Enterprise of San Jose, California and running a Red Hat Linux™ operating system marketed by Red Hat, Inc. of Raleigh, North Carolina; (b.) a Dell Precision™ computer workstation marketed by Dell Corporation of Round Rock, Texas, and running a Windows™ 10 operating system marketed by Microsoft Corporation of Redmond, Wash.; (d.) a Mac Pro workstation running MacOS X™ as marketed by Apple, Inc. of Cupertino, Calif.; (e.) a tablet such as an iPad Pro running iPadOS 16 as marketed by Apple, Inc. of Cupertino, Calif.; (f.) a smart phone such as an iPhone 14 Pro running iOS 16 as marketed by Apple, Inc. of Cupertino, Calif.; or (g.) other suitable computational system or electronic communications device known in the art capable of providing networking and operating system services as known in the art. The exemplary software program SW.SRC 1104H consisting of executable instructions and associated data structures is optionally adapted to enable the instructor device 1104 to perform, execute and instantiate all elements, aspects and steps as required of the instructor device 1104 to practice the invented method in its various preferred embodiments in interaction with other devices of the network 100. It is noted that, while a single integrated software program for practicing all elements of the invented method is presented here as a representation, and a single interface designed for composing the lessons 100 of the invented method would be preferred as user-friendly to the composer, multiple software programs might be used to compose the lessons 100 of the invented method and to publish the same lesson in different formats, such as but not limited to text editing software, image editing software, audio recording software, audio editing software, word processors, programs specializing in print layout for publication, web development software, or programming environments suitable for producing interactive software content. The memory 1104F may further include or provide storage for one or more lesson modules 11041, such as software packages containing complete instances of the lesson 100. The memory 1104F may further include one or more stored instances of the dictionary lexicon 102 or the phoneme map lexicon 106, represented here as a lexicon(s) 1104F, for use in composing new lesson modules. The memory 1104F may further include one or more stored instances of the phoneme map 104, represented here as a phoneme map(s) 1104G, for use in composing new lesson modules. The memory 1104F may further include a database of additional information about words 1104L of the stored lexicon(s), such as pronunciation data regarding individual words suitable for enabling a new phoneme map lexicon 106 to be assembled autonomously given a phoneme map 104 and a starting list of words whose pronunciation is recorded (such as the dictionary lexicon 102 as applied in FIG. 6). The memory 1104F may further include or provide storage for one or more drafts 1104M of incomplete instances of the lesson 100, or materials being utilized to assemble these such as but not limited to audio files, image files, text scratch, and/or reference material, particularly if this is the same workstation being utilized to compose the lessons 100. The memory 1104F may further include libraries 1104N for general use in composing the lessons 100, such as font libraries, audio libraries, clipart libraries, software libraries, and libraries associated with specific pieces of software, such as a template library included in a word processor application.

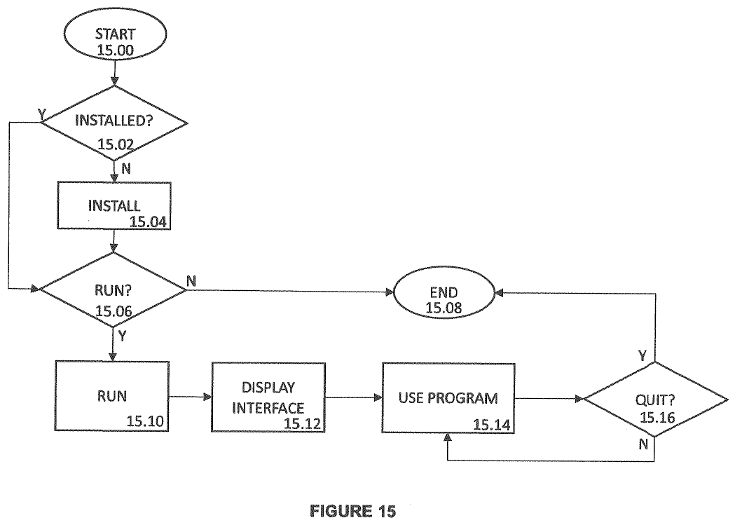

Referring now generally to the Figures, and particularly to FIG. 14A, FIG. 14A is a first flow chart presenting accessing of downloadable software containing educational material in practice of a preferred embodiment of the invented method, as practiced from the perspective of the student device 1102. It is noted that the student device 1102 is named for this device's role of receiving, using, and presenting premade language educational content as composed and provided utilizing the instructor device 1104, and that the student device 1102 does not literally have to be owned or operated by a user who is a student. It is noted that a software implementation including the invented method might be adapted to run on any suitable platform and operating system, such as but not limited to desktop computers, laptop computers, tablets, and smartphones, and might be made available in a wide variety of modes, such as but not limited to downloadable software, CD-ROM(s), a web browser version, or an App. It is noted that different embodiments may require different network transactions to occur—such as maintaining a streaming web connection over time to use a web browser version of the software, as opposed to downloading a software package once—and the present flow charts of FIGS. 14A and 14B should not be construed as a limitation on modes of network communications which may be used to practice network communications aspects of the invented method. It is further noted that even a web connection maintained over time, such as a streaming connection, entails sending and receiving packets of data over the network, and any data received over a network and instantiated on one's local device can be considered ‘downloaded’, even if no files are permanently stored or saved. At step 14.00, the process starts. In step 14.02, it is determined whether to request a download, such as a decision to make a software purchase or access a website. If not, the process may end without further action; otherwise, a request is sent over the network 1100 to initiate a download. Next, in step 14.06, the download commences, and continues until complete. In step 14.08, if the download is not complete yet, the student device 1102 waits for the download to complete. It is noted that most downloads of any significant filesize can take a little while, and that an interrupted download can often result in receipt of a partial file that is unusable. Once the download is complete, in step 14.10, there may be an additional installation step to complete in order to open the downloaded software package and allow access to the software. In step 14.12, the software is run, and the content is provided. The process ends at step 14.14.

Referring now generally to the Figures, and particularly to FIG. 14B, FIG. 14B is a flow chart presenting the instructor device 1104 side of the download process presented in FIG. 14A. It is noted that this process assumes that one or more software packages which include lesson modules for practicing the invented method have already been created, such as per other process charts of earlier Figures; this process presents making such a software package accessible to a party who would like to download and use what has already been created. It is further noted that the role of instructor device 1104 may be generally understood as the device on the network 1100 from which one might obtain created lesson modules for practicing the invented method, that this may be interpreted as a server function, and that this server function could be performed as a background process of someone's personal computer, such as the workstation of someone creating lesson modules, or as a function of a server solely dedicated to this task. At step 14.16, the process starts. At step 14.18, a request is awaited; if no request has been received, at step 14.20, the instructor device 1104 continues to wait for a request. Once a request is received, at step 14.22, the instructor device 1104 verifies that the request is authorized; for instance, if the software is for sale, a download may not be initiated until receipt of payment is confirmed, or a license code is provided, or subscription access may require a login. It is noted that there is a possibility the authorization step could fail, such as if access is NOT in fact authorized, and the process could potentially end there without completing, or stall until proper authorization is provided. Once authentication is received, at step 14.26, one or more data packets is sent to the source of the request, with the data packets together comprising the requested software content. This process continues, at step 14.26, until complete. Once the transfer of data packets is complete, the process ends at step 14.28. It is noted that this chart only presents a single iteration of completion of this task, and that, to instantiate a server function of responding to multiple requests as and when each is received, one might run this flow chart as an endless loop broken only by turning off the instructor device 1104.

A first arrow 1400 and a second arrow 1402 are also drawn here as dotted lines to show network traffic “going between” the flow charts of FIGS. 14A and 14B, where these processes may indirectly interact or line up; the request sent at step 14.04 of FIG. 14A may be the same request received at step 14.18 of FIG. 14B, and the packets sent in response at step 14.24 may be the download received and handled at steps 14.06 and 14.08. However, it is also noted that, from the perspective of each device, all that's happening is items being sent or received; each device sends whatever is indicated to send, and responds appropriately to whatever may be received.

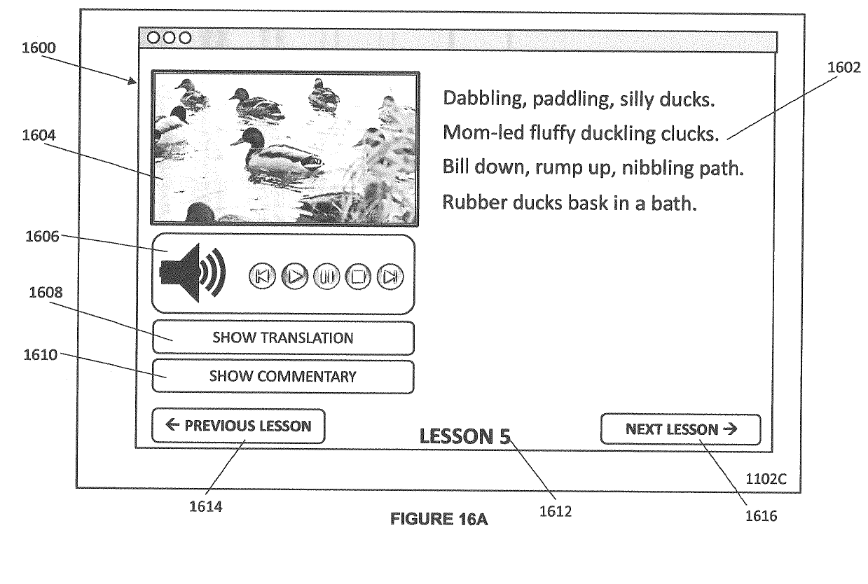

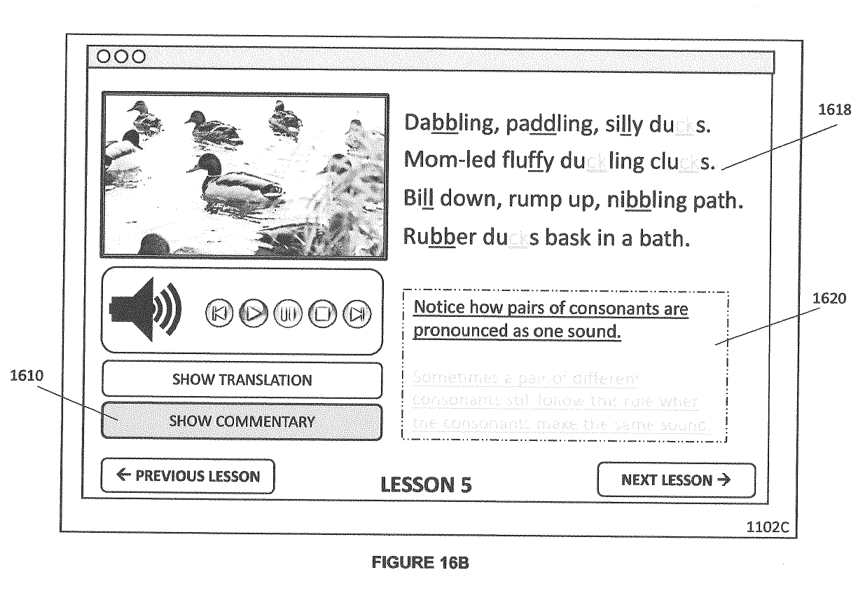

Referring now generally to the Figures, and particularly to FIG. 15, FIG. 15 is a process chart presenting a process of the student device 1102 using a received software package to present an interface for a user to interact with, such as the example software interface 1600 of FIGS. 16A and 16B as rendered on the display module 1102C. At step 15.00, the process starts. At step 15.02, it is determined whether any installation steps for unpacking a received software package into a usable format have been completed. If not, at step 15.04, this is done. At step 15.06, a choice is made by a user of whether to run the software; if the software is not being run at this time, the process ends at step 15.08. Otherwise, running of the software is initiated by a user, such as by clicking or tapping an icon, button, or shortcut, or entering an appropriate command line script. At step 15.12, the student device 1102 accesses elements of the software to render and display a user interface, such as the example software interface 1600 of FIGS. 16A and 16B. In step 15.14, the user interacts with the program by utilizing the user interface, such as by looking at the content onscreen, clicking or tapping on elements of the onscreen content, or listening to audio content associated with the rendered onscreen content. At step 15.16, a choice is made by the user as to whether to quit the program (it is noted that the user's progress might also be saved, if this is relevant to do). If the user does not quit, use of the program continues; otherwise, the process ends at step 15.08.

Referring now generally to the Figures, and particularly to FIG. 16A, FIG. 16A is a first depiction of an example software interface 1600 as rendered on the display module 1102C and presenting the example poem 702 and other aspects of the example of FIGS. 7A through 9B in the context of an interactive software program. It is noted that, while the example software interface 1600 is aesthetically presented as a desktop computer window, with a title bar and the standard close/minimize/maximize buttons at the top, a software implementation including the invented method might be adapted to run on any suitable platform and operating system, such as but not limited to desktop computers, laptop computers, tablets, and smartphones, and might be made available in a wide variety of modes, such as but not limited to downloadable software, CD-ROM(s), a web browser version, or an App. The example software interface 1600 presented here depicts an example screen view containing several preferred items which might be included in such an implementation, such as a poem text 1602 presenting the text of the example poem 702, a picture 1604 thematically suited to the poem text 1602, an audio playback interface 1606 with buttons to provide access to an audio recording of the poem text 1602 being read aloud; a “SHOW TRANSLATION” button 1608 which might be included to enable a student to selectively reveal text of the poem in a language more familiar to that student; a “SHOW COMMENTARY” button 1610 which might be included to allow for a feature of selectively revealing text further explicating key features of interest in the poem text 1602; a lesson title 1612 for navigation; a “PREVIOUS LESSON” button 1614 for navigation; and a “NEXT LESSON” button 1616 for navigation. It is noted that the example poem 702 was selected as an example element to visually demonstrate the concept, and that no limitations should be construed as to the invented method including this specific text, the subject matter of ducks, or other aspects specific to this particular example poem. It is further noted that a bilingual interface may be preferred (though not always) for a student learning a new language, such as one presenting elements of the lesson 100 itself in the target language being learned and facilitating elements like the “PREVIOUS LESSON” button 1614 and the “NEXT LESSON” button 1616 being labeled instead in a language already known by the student. For simplicity of illustration, all elements of the example software interface 1600 as presented here are in English, and the potential incongruency of depicting an interface labeled entirely in the same language as the lesson 100—a language which a target audience user specifically doesn't know and is trying to learn—is acknowledged in passing. It is further noted that some language learners may benefit from interacting with an interface which is also labeled in the target language; pressing a labeled button and watching something happen in response is a good way of learning and what the label text means and reinforcing that association through practice.

Referring now generally to the Figures, and particularly to FIG. 16B, FIG. 16B is a second depiction of the example software interface 1600 of FIG. 16A as rendered on the display module 1102C, and presenting further aspects. Specifically, a possible screen view of the same interface of FIG. 16A with the “SHOW COMMENTARY” button 1610 having been activated (such as by being clicked on, tapped with a finger on a touch screen, or otherwise relevantly interacted with by a user) is presented, revealing an annotated poem text 1618 which corresponds to elements explained in a commentary text section 1620. It is noted that more in-depth discussions as to rules of grammar or linguistic quirks might be preferably presented in a language the user already knows, with the annotated poem text 1618 pointing out corresponding examples; as mentioned above, all example elements are being presented in English, with the understanding both that English is not the only language one might study, and that the interface may be better presented utilizing different languages for different elements, such as presenting the poem text 1602 in a student's target language but notes explaining concepts of phonetics and grammar in a language that student already knows. It is noted that color-coding of a first commentary point as black and a second commentary point as grey is corresponding in the annotated poem text 1618, with examples of the first point such as the “bb” in the word “dabbling” being underlined and colored black, and examples of the second point such as the “ck” in “ducks” being underlined and colored grey.

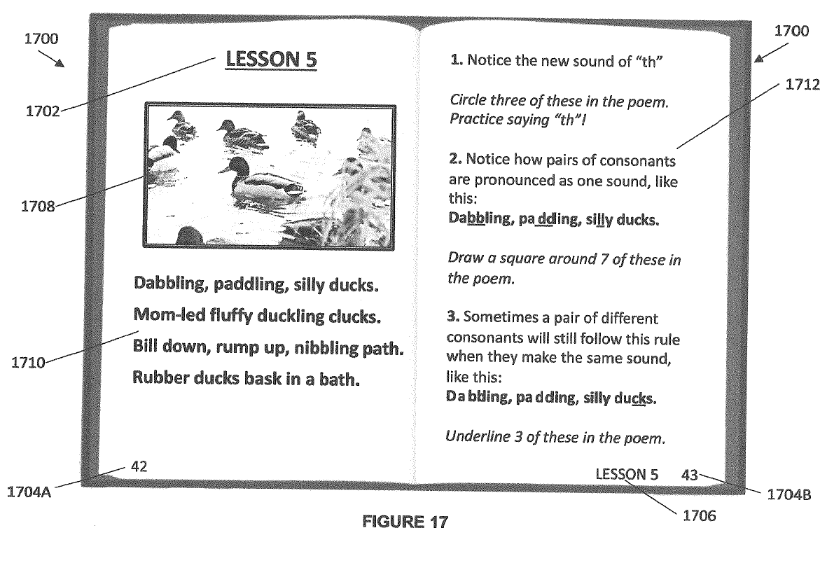

Referring now generally to the Figures, and particularly to FIG. 17, FIG. 17 is a depiction of an example first printed book page 1700 and an example second printed book page 1702, presenting the example poem 702 and other aspects of the example of FIGS. 7A through 9B in the context of a printed book such as a textbook or workbook written for a language learner. The printed book in general and the example first printed book page 1700 and the example second printed book page 1702 specifically may include or contain organizational elements such as a section title 1702, page numbers 1704A & 1704B, a footer 1706, and so on. Included educational content might incorporate an image 1708, a book poem text 1710, and additional book content 1712 such as informative commentary or educational activities as presented here.

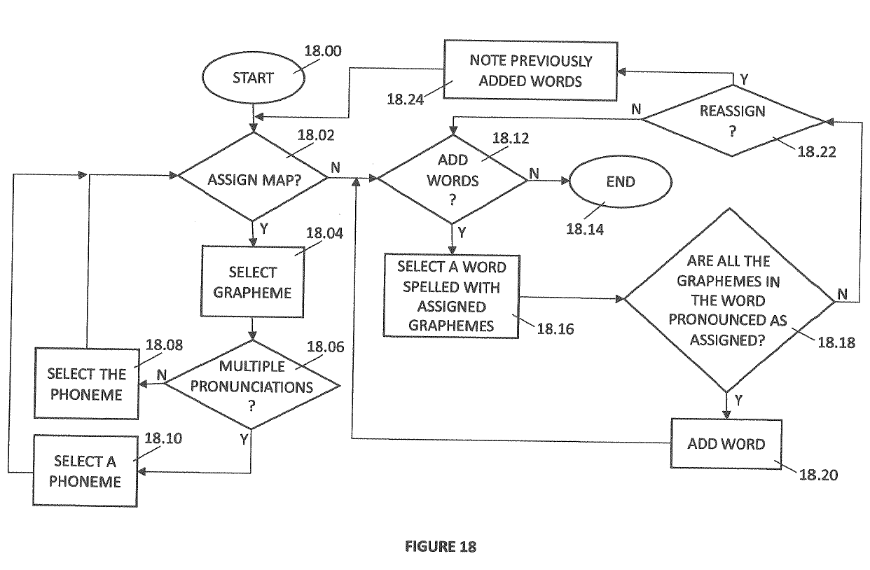

Referring now generally to the Figures, and particularly to FIG. 18, FIG. 18 is a process chart presenting a possible process for assembling the phoneme map 104 and phoneme map lexicon 106. At step 18.00, the process starts. At step 18.02, it is determined whether to add an item to the phoneme map 104, i.e. map a phoneme onto a grapheme, such as setting a rule that all letters “S” in the scope of this phoneme map 104 are pronounced [s]. At step 18.04, a grapheme is selected to be paired to a phoneme (recalling that a “grapheme” is a unit of written language such as a letter or combination of letters, and a “phoneme” is a unit of spoken language such as a vowel or consonant sound). At step 18.06, it is determined whether the grapheme has multiple appropriate pronunciations. For some graphemes, such as many consonants, there is only one corresponding phoneme, and therefore no choice to make as to which phoneme should be assigned; at step 18.08, if so, the appropriate phoneme is assigned. If there are multiple phonemes to choose from, the composer selects one of these. It is noted that what the available options are for phonemes to be assigned, or which particular words are “close enough” to a selected phoneme option to be included by selection of that phoneme option or excluded by non-selection, are all subjective decisions left to the ear and discretion of the composer.

It is noted that each item on the phoneme map 104 might be understood as a limited expansion of the scope of what words might be included in the lesson 100 as defined by the phoneme map 104; in preferred practice of the invented method, only words whose graphemes (a.) are included on the phoneme map 104 and (b.) whose pronunciation has been determined to reasonably correspond to the phoneme map 104, can be included. The conditional step 18.02 is positioned to control a loop, allowing for multiple pairings of grapheme and phoneme on the phoneme map 104 to be assigned. It is noted that not all alphabet letters have to be included in the phoneme map 104 (though composition of the lesson 100 may be limited to only including those that are), and further that the structuring of the method presented on this chart allows for a composer to assign some items of the phoneme map 104, determine which words that makes available for composition, and later go back to assigning and expand the phoneme map or even change their mind about a previous assignment of phoneme to grapheme (such as the composer deciding, per the above example, that the letter “S” would be better used to incorporate words that pronounce the letter “S” as [z] instead), building up the phoneme map 104 and phoneme map lexicon 106 together. It is further noted that this may also further or alternatively be done alongside composing the lesson 100 itself.

Once enough of the phoneme map 104 is assigned, some words might be selected in accordance with the phoneme map 104; a determination of whether to add words and how many is made at step 18.12, and when the composer considers the phoneme map lexicon 106 sufficiently populated for composing the lesson 100, the process ends at step 18.14.

It is understood, and as noted in the text accompanying FIG. 1, that when second language word is written with graphemes indexed by the phoneme map 104 that may be pronounced by the associated phoneme values as found in the phoneme map 104, then the second language word may be included in the phoneme map lexicon 106 in the composing process of FIG. 1 in generating the lesson 100, and/or other alternate preferred embodiments of text in accordance with various alternate preferred embodiments of the invented method.

Otherwise, a word including only graphemes assigned on the phoneme map 104 is selected at step 18.16 for consideration. At step 18.18, it is determined whether the selected word of step 18.16 is suitable for inclusion in the phoneme map lexicon 106; i.e. whether all of the graphemes of that word are pronounced as the phoneme map 104 specifies, or within a reasonable approximation as judged by the composer. If so, the word is added at step 18.20 and the loop continues with potentially adding a next word. If not, the option is provided at step 18.22 to revise the phoneme map 104. For instance, it may be the case that the composer attempted to include a word that the composer really wanted to use or considers essential; if so, then the composer might choose to revise the phoneme map 104 to support that creative decision, taking into account at step 18.24 what other words might have already been selected (which might be excluded by revision of the phoneme map 104). It is noted that what is prioritized is internal consistency of pronunciation, and, while some instances of the lesson 100 might assign certain phoneme map 104 elements with specific educational goals in mind (such as teaching a specific phonetic rule or practicing pronunciation of a certain sound), the phoneme map 104 assignments may also be fairly arbitrary, and could be modified if preferred as the composition process continues, such that the availability of consistent words is aligned with the composer's creative intention.

It is noted that a computer practicing or assisting this process might simply determine the list of all available words compossible with the current phoneme map 102, and that for any given word to be “available” for the computer to make this determination, a human user may still need to specify to the computer what phonemes that word is considered to contain, providing the subjective pronunciation judgment call “in advance” to be accessed as needed.

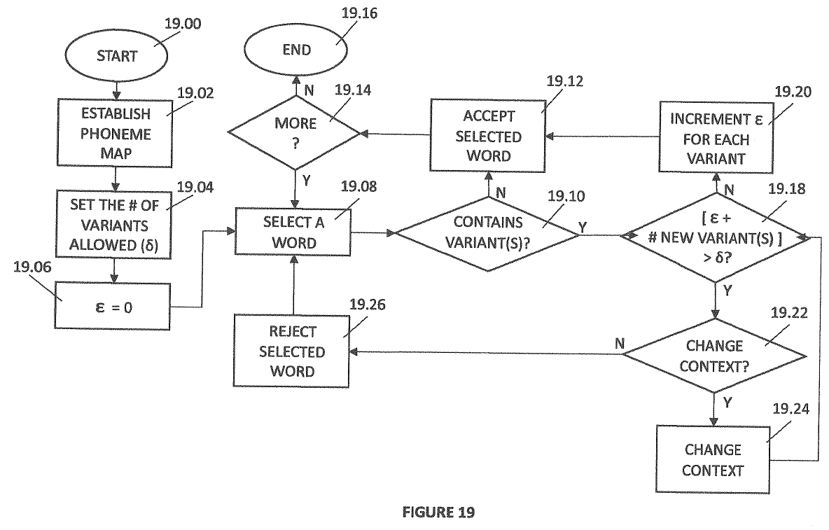

Referring now generally to the Figures and particularly to FIG. 19, FIG. 19 is a process chart presenting aspects of a further alternative embodiment of the invented method, specifically allotting an allowance of variants which break the pattern established by the phoneme map 104 and composing the lesson 100 within that imposed limitation margin. At step 19.00, the process starts. At step 19.02, the phoneme map 104 is established. It is noted that other steps of other method embodiments may also be practiced, such as establishing the dictionary lexicon 102, the phoneme map lexicon 106, or the allowable lexicon 108, as preferred by the composer. In step 19.04, a variant budget δ (delta) is established, which may be based on a variant percentage β%; as an example, and not a limitation, a composer might set the rule that no more than two graphemes per quatrain are permitted to not be pronounced in accordance with the phoneme map 104. It is noted that in various certain alternate preferred embodiments of the invented method any number of variants may be permitted (though a sensible composer would understand that, beyond a certain high threshold, one may as well not be setting a limit), and that a budget N per amount of words or letters can be maintained, such as but not limited to “per quatrain”, “per page”, “per one hundred words”, “per lesson”, and so on, and that this process is considered to represent composition of a single section having a same budget; for instance, moving on to a new section (i.e., starting a second quatrain, a new page, a next hundred words, or a next lesson) and resetting the counter to 0 for a next budget, is not presented here. It is further noted that whether unused allowance of variants ‘carries over’ to a new section may be a relevant consideration for a composer in establishing rules for authoring the lesson 100.

It is understood that in certain still alternate preferred embodiments of the invented method, a limit of no more than ten variant pronunciations per one hundred graphemes of lesson 100 is permitted. It is understood that in certain even alternate preferred embodiments of the invented method, a limit of no more than four variant pronunciations per one hundred graphemes of lesson 100 is permitted. It is understood that in certain even alternate preferred embodiments of the invented method, a limit of no more than ten variant pronunciations per instance of the lesson 100 is permitted. It is understood that in certain even alternate preferred embodiments of the invented method, a limit of no more than four variant pronunciations per instance of the lesson 100 is permitted.

The number of variants allowed is referenced in the process chart as the variable δ. At step 19.06, a counter variable ε is initialized to 0, with the counter variable ε being the number of variants currently present in the text, to be compared against the variant budget δ. With these setup steps complete, composition begins with step 19.08, in which a first word is selected. At step 19.10, it is determined whether the currently selected word contains one or more phonetic variants; that is, whether any of the graphemes of the word are not considered to be pronounced as mapped on the phoneme map 104. If not, then the word is accepted and added at step 19.12. At step 19.14, it is determined whether the lesson 100 is complete; if so, the process ends at step 19.16, and otherwise, the process continues back around to step 19.08 to select a next word. However, if the currently selected word contains one or more variants, then next, at step 19.18, it is determined whether adding the new word would cause the lesson 100 to exceed the variant budget δ as established in step 19.04—that is, whether adding the number of variants in the current word to the current value of the counter variable ε (which is tracking the current number of variants total) would sum to an amount greater than or equal to A. If not, then at step 19.20, the counter variable ε is incremented for each new variant, but the new word remains “within budget” and is therefore permitted. However, if the new word would cause the lesson 100 to exceed the variant budget δ, then an option may be provided at step 19.22 to alter the composition parameters, such as modifying the phoneme map 104 or changing the variant budget δ; the composer may realize in the process of composing that the variant budget δ has been set too low, or a different suitable allotment of the phoneme map 104 would work better for what is being composed. It is noted that variants are preferably used sparingly, and a smart composer will probably conserve variants if possible by defining the phoneme map 104 strategically and preferring words completely allowed by the phoneme map 104 where possible. The variant budget δ as a mechanism for allowing limited presence of variants might be viewed as a recognition, in certain other alternate preferred embodiments of the invented method, that some limited margin off of strict adherence to the phoneme map 104 is permissible, and provide some leeway for the composer to exercise judgment where perfect adherence to the phoneme map 104 may be weighed against other considerations, such as modeling good grammar, using words appropriate to the student's age level, or demonstrating a particular linguistic feature of interest. Inasmuch as there is a strategic element to the composition process, this step may be considered an opportunity for the composer to revise strategy in view of developments in the composition process. If the context is modified, it is noted that other revision may be required, such as considering whether revising the phoneme map 104 “breaks” any words previously selected and introduces new variants. In any case, Once the context is modified at step 19.24, it is reconsidered whether the variant budget δ has been exceeded. If the currently selected word exceeds the variant budget δ and no modifications to the limitations on what words can be utilized are made, then the new word is rejected at step 19.26; the composer will simply have to select a different word to use instead. It is noted that this process chart presents a linear composition process wherein one word is selected at a time, and no accounting is made for the composer revisiting previous phrases, placing words or phrases out of order, or making global adjustments to the lesson 100 as a whole, while a composer may see fit to do any of these. It is understood that presentation of this particular aspect of budgeting variants in a linear fashion is not intended as a limitation on the composition process. It is further noted that a computer interface which provides automatic tracking of the counter variable ε in view of the phoneme map 104 and the words entered by the composer (in whatever order or format), and alerts the composer whenever the counter variable ε exceeds a preset variant budget δ, might be a very useful and practical implementation of software-enabled support in practicing the invented method.

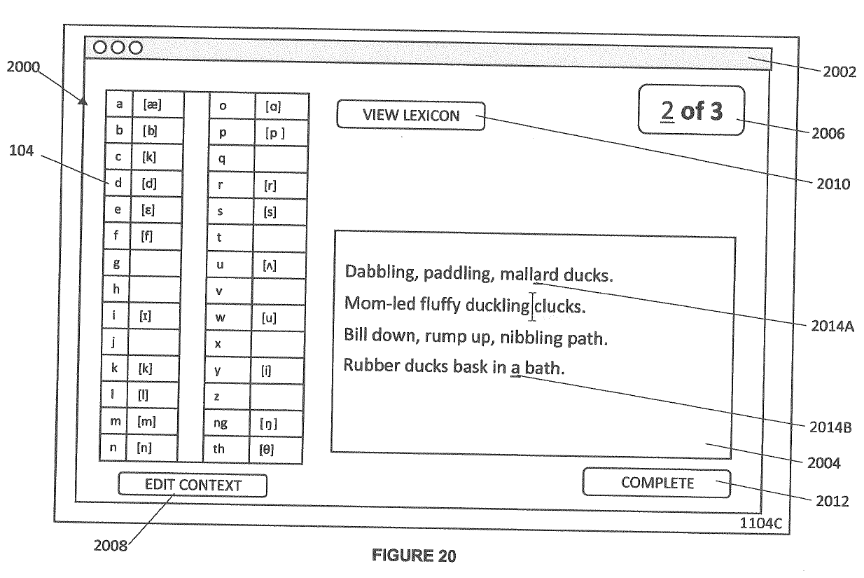

Referring now generally to the Figures and particularly to FIG. 20, FIG. 20 is an exemplary composition software interface 2000 as presented on a monitor screen operated by the display module 1104C of the instructor device 1104, adapted for facilitating practice of preferred aspects of the invented method including the budgeting of FIG. 19. It is understood that the interface presented here is an example only, and may not comprehensively include all interface elements which could potentially be useful for someone practicing the invented method. It is noted that, to aesthetically depict a software interface, the drawing includes a title bar 2002 as may frame a standard software window, including the close, minimize, and maximize buttons in the upper left corner standard for Apple OSX software interfaces. It is noted that practice of the invented method or any software utilities to support the invented method isn't limited by operating system, and these elements are only depicted to present the context of a software interface. The exemplary composition software interface 2000 may usefully include elements such as a display of the phoneme map 104, a text editor 2004, a variant display 2006, an EDIT CONTEXT button 2008 for editing context factors such as the phoneme map 104 or the variant budget δ as discussed at least in FIG. 19, a VIEW LEXICON button 2010 for viewing a list of words consistent with the current phoneme map 104 (such as for inspiration), and a COMPLETE button 2012 for designating the current composition complete. Further interface features shown here include variant markup 2014A & 2014B, showing how the 2 in the “2 of 3” of the variant display 2006 (indicating the counter variable ε and the variant budget δ respectively; three variants total are permitted and two of these are currently counted) has been calculated and which graphemes are considered pronounced inconsistently, in case the composer would like to modify these. Other buttons or features which might usefully be included may include a button for accessing dictionary, thesaurus, rhyming dictionary, saved resources such as research on the topic, or other reference materials; or a button for adding a new word or asking the computer to show how a word's pronunciation has been interpreted (and allowing correction if the computer is wrong).

While selected embodiments have been chosen to illustrate the invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment, it is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

1. A pedagogical method wherein one or more instructors (hereinafter, “the instructor”) perform the following aspects:
a. the instructor selecting a spoken language having a standard alphabet of characters (hereinafter, “graphemes”);
b. the instructor assigning one and only one phoneme to each grapheme, wherein unique phoneme-grapheme pairings are formed;
c. the instructor selecting a first plurality of words of the spoken language, wherein every grapheme of the first plurality of words conforms to the phoneme-grapheme pairings of aspect b;
d. the instructor forming a plurality of phrases, each having two or more words selected from the first plurality of words; and
e. the instructor presenting the plurality of phrases to a language learner.

2. The method of claim 1, wherein at least four phrases are structured as a quatrain.

3. The method of claim 2, wherein the quatrain instantiates a rhythmic pattern.

4. The method of claim 2, wherein the quatrain instantiates a rhyming pattern.

5. The method of claim 1, wherein a plurality of quatrains is formed that contain words selected from the first plurality of words.

6. The method of claim 1, wherein a plurality of quatrains is formed that contain only words selected from the first plurality of words.

7. (canceled)

8. The method of claim 1, wherein the first plurality of words is presented to a language learner in association with related imagery.

9. The method of claim 8, wherein the first plurality of words is published in print media.

10. The method of claim 1, wherein the first plurality of words is rendered on a video screen of a computational device.

11. The method of claim 1, further comprising:
f. repeating aspects d and e with a series of pluralities of phrases, wherein each plurality of phrases is a unique combination of words; and
g. presenting a non-conforming plurality of phrases, wherein at least one grapheme of the non-conforming plurality of phrases varies in pronunciation from at least one restriction of the grapheme-phoneme pairings.

12. The method of claim 11, wherein at least one alternative word of the non-conforming plurality of phrases is presented visually distinctly from the words of the first plurality of words.

13. The method of claim 12, wherein the at least one alternative word is presented in an alternative coloring that is visually distinct from a color by which the first plurality of words is presented.

14. The method of claim 11, further comprising a second alternative word, wherein at least one grapheme of the plurality of words is repeated within the plurality of words and with an alternate pronunciation than the phoneme assigned in the corresponding grapheme-phoneme pairing.

15. The method of claim 11, wherein an additional grapheme of the non-conforming plurality of phrases varies in pronunciation from at least one restriction of the grapheme-phoneme pairings.

16. The method of claim 1, aspect e, further comprising:
Storing the first plurality of words in a computer-readable medium and
Visually rendering at least a selection of the plurality of phrases via a computational device to a language learner.

17. The method of claim 16, further comprising providing a digitized record of the plurality of phrases to the computational device via a network-enabled computer.

18. The method of claim 16, further comprising providing an accessible audio record of a pronunciation of at least a portion of the words included in the plurality of phrases to the computational device.

19. The method of claim 16, further associating an accessible audio record of a pronunciation of at least one the word included in the phrases with a digitized record of said at least one word.

20. The method of claim 16, wherein at least one alternative word that instantiates an alternative phonetic value of a grapheme included in the plurality of phrases is selected, and the at least one alternative word is presented to the language learner within a phrase.

21. The method of claim 1, further comprising including within the first plurality of words at least one instance of a selected grapheme that is associated with a second pronunciation that phonetically varies from an alternate pronunciation of another instance of the selected grapheme within a first plurality of graphemes presented within the first plurality of words.

22. The method of claim 1, further comprising including within the first plurality of words a plurality of β% instances of selected graphemes that are each associated with an alternate pronunciation that phonetically varies from a pronunciation of another instance of each selected grapheme within the first plurality of γ graphemes, wherein β% is less than or equal to 10% of γ graphemes.

23. The method of claim 1, further comprising including within the first plurality of words a plurality of β% instances of selected graphemes that are each associated with an alternate pronunciation that phonetically varies from a pronunciation of another instance of each selected grapheme within the first plurality of γ letters wherein β% is less than or equal to 10% of γ letters.

24. The method of claim 1, further comprising including within the first plurality of words a plurality of β% instances of selected graphemes that are each associated with an alternate pronunciation that phonetically varies from a pronunciation of another instance of each selected grapheme within the first plurality of γ words wherein β% is less than or equal to 10% of γ words.

25. The method of claim 1, further comprising including within the first plurality of words a plurality of β% instances of selected graphemes that are each associated with an alternate pronunciation that phonetically varies from a pronunciation of another instance of each selected grapheme within the first plurality of γ quatrains wherein β% is less than or equal to 10% of γ quatrains.

26. The method of claim 1, wherein the first plurality of words comprises all words which are available to select from a designated dictionary, wherein each grapheme as present in all spellings of the first plurality of words shares a same common usage pronunciation in every instantiation of said grapheme.

27. A pedagogical method, the pedagogical method comprising:
a. A language instructor generating a first portfolio of language instruction materials wherein a standard alphabet for a target language is utilized and a vocabulary restriction is applied such that the first portfolio of language instruction materials contains only words wherein each grapheme as present in all spellings of the first plurality of words shares a same common usage pronunciation in every instantiation of said grapheme within the first plurality of words;
b. The language instructor presenting the first portfolio of language instruction materials to a language student;
c. The language student studying the first portfolio of language instruction materials until competent in applying the same common usage pronunciation of each grapheme as presented in the first portfolio of language instruction materials;
d. The language instructor generating a second portfolio of language instruction materials wherein one or more selected modifications to the vocabulary restriction are further added into the first portfolio of language instruction materials;
e. The language instructor presenting the second portfolio of language instruction materials to the language student, and the student studying the second portfolio of language instruction materials until competent in recognizing and applying the selected modifications;
f. Repetition of steps (c.) through (e.), to build further competency through practice and introduction of further variations from the common usage pronunciation as initially introduced, as considered suitable by the language instructor; and
g. The language student achieving an improved competency level suitable for reading written materials in the target language which are not limited according to grapheme pronunciation or the selected modifications.

28. A method for generating teaching materials, the method comprising:
a. Selecting a dictionary lexicon containing a plurality of words of a written and spoken language to be taught (“the target language”);
b. Researching usage of the target language to determine one or more correct verbal pronunciations for each written grapheme present in the dictionary lexicon;
c. Defining a phoneme map wherein each written grapheme present in the dictionary lexicon is paired to exactly one pronunciation of the one or more correct verbal pronunciations pertaining to that grapheme;
d. Generating an applicable lexicon by selecting only those words from the dictionary lexicon wherein all graphemes of the word are pronounced consistently to the phoneme map; and
e. Generating teaching materials wherein all words presented for a student to read are selected from the applicable lexicon.

29. The method of claim 28, wherein the phoneme map is generated by selecting a most frequently used pronunciation of each grapheme as determined by surveying of the dictionary lexicon.

30. The method of claim 28, further comprising selection from the dictionary lexicon of a plurality of key words preferred for inclusion in a portfolio of learning materials, and defining the phoneme map such that the plurality of key words will be included in the applicable lexicon.

31. The method of claim 28, wherein a software application running on a computer is utilized to perform the task of assembling the applicable lexicon, with the dictionary lexicon, the phoneme map, and information regarding correct word pronunciation provided as data input.

32. The method of claim 28, wherein the dictionary lexicon is a standard dictionary of the target language.

33. The method of claim 28, wherein the dictionary lexicon is selectively adapted from a standard dictionary of the target language.

34. The method of claim 1, wherein the instructor performing one or more aspects a through e includes a different person.

35. The method of claim 1, wherein the instructor performing one or more aspects a through e comprises an information technology system.
